(19) United States
(12) Patent Application Publication
(10) Pub. No.: US 2022/0317418 A1
(43) Pub. Date: Oct. 6, 2022

(54) Optical Imaging Lens Assembly

(71) Applicant: ZHEJIANG SUNNY OPTICS CO.,LTD., Ningbo (CN)

(72) Inventors: Yifu CHENG, Ningbo (CN); Mengna TANG, Ningbo (CN); Jianke WENREN, Ningbo (CN); Fujian DAI, Ningbo (CN); Liefeng ZHAO, Ningbo (CN)

(21) Appl. No.: 17/691,143

(22) Filed: Mar. 10, 2022

(30) Foreign Application Priority Data
Apr. 1, 2021 (CN) 202110354558.X

(51) Int. Cl. G02B 9/64; G02B 13/00

(52) U.S. Cl. CPC G02B 9/64; G02B 13/0045

(57) ABSTRACT

The disclosure provides an optical imaging lens assembly, sequentially including from an object side to an image side along an optical axis: a first lens having a refractive power; a second lens having a negative refractive power; a third lens having a refractive power; a fourth lens having a negative refractive power; a fifth lens having a negative refractive power; a sixth lens having a refractive power, an object-side surface thereof being a concave surface, and an image-side surface thereof being a convex surface; and a seventh lens having a refractive power; wherein TTL, a distance from an object-side surface of the first lens to an imaging surface of the optical imaging lens assembly along the optical axis and f, a total effective focal length of the optical imaging lens assembly satisfy TTL/f<1.

### CROSS-REFERENCE TO RELATED PRESENT INVENTION(S)

The disclosure claims priority to and the benefit of Chinese Patent Disclosure No.202110354558.X, filed in the China National Intellectual Property Administration (CNIPA) on 1 Apr. 2021, which is incorporated herein by reference in its entirety.

### TECHNICAL FIELD

The disclosure relates to the field of optical elements, in particular to an optical imaging lens assembly.

### BACKGROUND

With various portable electronic products like smart phones booming, higher requirements are imposed on the optical imaging lens assembly mounted on the portable electronic products. The telephoto lens has high practicability in the actual photographing process, and can generate perspective illusion apart from small visual angle and blurring function, thereby being favored by increasing consumers and gradually becoming a standard accessory of mobile phone lenses.

However, a conventional telephoto lens cannot meet the continuously updated design requirements of the electronic products, so the structure of the telephoto lenses needs to be improved and optimized. How to integrate the high imaging quality, the effect of long-distance photographing and a larger aperture into the telephoto lens under the condition of guaranteeing the structural manufacturability needs to be solved urgently in the field.

### SUMMARY

An embodiment of the disclosure provides an optical imaging lens assembly, sequentially including from an object side to an image side along an optical axis: a first lens having a refractive power; a second lens having a negative refractive power; a third lens having a refractive power; a fourth lens having a negative refractive power; a fifth lens having a negative refractive power; a sixth lens having a refractive power, an object-side surface thereof being a concave surface, and an image-side surface thereof being a convex surface; and a seventh lens having a refractive power; where TTL, a distance from an object-side surface of the first lens to an imaging surface of the optical imaging lens assembly along the optical axis and f, a total effective focal length of the optical imaging lens assembly satisfy TTL/f<1, and ImgH, a half of a diagonal length of an effective pixel region on the imaging surface and Semi-FOV, a half of a maximum field of view of the optical imaging lens assembly satisfy 8 mm<ImgH/tan(Semi-FOV).

In an implementation mode, TTL, the distance from the object-side surface of the first lens to the imaging surface along the optical axis, f, the total effective focal length of the optical imaging lens assembly, and Semi-FOV, the half of the maximum field of view of the optical imaging lens assembly may satisfy: 2.5<TTL/f/tan(Semi-FOV).

In an implementation mode, Semi-FOV, the half of the maximum field of view of the optical imaging lens assembly and Fno, an f number of the optical imaging lens assembly may satisfy: 0.5<tan(Semi-FOV)*Fno<1.

In an implementation mode, EPD, an entrance pupil diameter of the optical imaging lens assembly and ImgH, a half of the diagonal length of the effective pixel region on the imaging surface may satisfy: 1<EPD/ImgH<1.5.

In an implementation mode, f1, an effective focal length of the first lens, f2, an effective focal length of the second lens, f3, an effective focal length of the third lens, and f123, a combined focal length of the first lens, the second lens, and the third lens may satisfy: (f1+f2+f3)/f123<1.

In an implementation mode, f123, the combined focal length of the first lens, the second lens and the third lens and f, the total effective focal length of the optical imaging lens assembly may satisfy: f123/f<0.5.

In an implementation mode, f4, an effective focal length of the fourth lens and f5, an effective focal length of the fifth lens may satisfy: 2<(f4+f5)/f<0.

In an implementation mode, TD, a distance from an object-side surface of the first lens to an image-side surface of the seventh lens along the optical axis, CT7, a center thickness of the seventh lens, and T67, a spacing distance between the sixth lens and the seventh lens along the optical axis may satisfy: 2.5<TD/(CT7+T67)<3.

In an implementation mode, T12, a spacing distance between the first lens and the second lens along the optical axis, T23, a spacing distance between the second lens and the third lens along the optical axis, T34, a spacing distance between the third lens and the fourth lens along the optical axis and T45, a spacing distance between the fourth lens and the fifth lens along the optical axis may satisfy: (T12+T23+T34)/T45<1.

In an implementation mode, T45, a spacing distance between the fourth lens and the fifth lens along the optical axis, T56, a spacing distance between the fifth lens and the sixth lens along the optical axis, and T67, a spacing distance between the sixth lens and the seventh lens along the optical axis may satisfy: 1<T67/(T45+T56)<2.

In an implementation mode, Nmin, a minimum value of refractive indexes of the first lens to the seventh lens may satisfy: 1.5<Nmin.

In an implementation mode, V5, an Abbe number of the fifth lens and V6, an Abbe number of the sixth lens may satisfy: 2<V5/V6<3.

In an implementation mode, f4, an effective focal length of the fourth lens and R7, a curvature radius of an object-side surface of the fourth lens may satisfy: 1<f4/R7<2.

In an implementation mode, f, a total effective focal length of the optical imaging lens assembly, R9, a curvature radius of an object-side surface of the fifth lens, and R10, a curvature radius of an image-side surface of the fifth lens may satisfy: 2<f/R10−f/R9<3.

The disclosure further provides an optical imaging lens assembly, sequentially including from an object side to an image side along an optical axis: a first lens having a refractive power; a second lens having a negative refractive power; a third lens having a refractive power; a fourth lens having a negative refractive power; a fifth lens having a negative refractive power; a sixth lens having a refractive power, an object-side surface thereof being a concave surface, and an image-side surface thereof being a convex surface; and a seventh lens having a refractive power; where TTL/f<1, and 2.5<TTL/f/tan(Semi-FOV), TTL being a distance from an object-side surface of the first lens to an imaging surface along the optical axis, f being a total effective focal length of the optical imaging lens assembly, and Semi-FOV being half of a maximum field of view of the optical imaging lens assembly.

The disclosure employs a seven-piece lens structure, the focal power and a surface type of each lens, the center thickness of each lens, the on-axis distance between the lenses, etc. are reasonably distributed, and accordingly, the optical imaging lens assembly has at least one beneficial effect of a larger aperture, a smaller depth of field, etc. while meeting an imaging requirement.

### BRIEF DESCRIPTION OF THE DRAWINGS

Other features, objectives, and advantages of the disclosure will become more apparent by means of the detailed description on non-limiting embodiments, in conjunction with the accompanying drawings. In the drawings:

FIG. 1 shows a structural schematic diagram of an optical imaging lens assembly according to Embodiment 1 of the disclosure;

FIGS. 2A-2D show a longitudinal aberration curve, a lateral color curve, an astigmatism curve and a distortion curve of the optical imaging lens assembly of Embodiment 1 respectively;

FIG. 3 shows a structural schematic diagram of an optical imaging lens assembly according to Embodiment 2 of the disclosure;

FIGS. 4A-4D show a longitudinal aberration curve, a lateral color curve, an astigmatism curve and a distortion curve of the optical imaging lens assembly of Embodiment 2 respectively;

FIG. 5 shows a structural schematic diagram of an optical imaging lens assembly according to Embodiment 3 of the disclosure;

FIGS. 6A-6D show a longitudinal aberration curve, a lateral color curve, an astigmatism curve and a distortion curve of the optical imaging lens assembly of Embodiment 3 respectively;

FIG. 7 shows a structural schematic diagram of an optical imaging lens assembly according to Embodiment 4 of the disclosure;

FIGS. 8A-8D show a longitudinal aberration curve, a lateral color curve, an astigmatism curve and a distortion curve of the optical imaging lens assembly of Embodiment 4 respectively;

FIG. 9 shows a structural schematic diagram of an optical imaging lens assembly according to Embodiment 5 of the disclosure;

FIGS. 10A-10D show a longitudinal aberration curve, a lateral color curve, an astigmatism curve and a distortion curve of the optical imaging lens assembly of Embodiment 5 respectively;

FIG. 11 shows a structural schematic diagram of an optical imaging lens assembly according to Embodiment 6 of the disclosure; and

FIGS. 12A-12D show a longitudinal aberration curve, a lateral color curve, an astigmatism curve and a distortion curve of the optical imaging lens assembly of Embodiment 6 respectively.

### DETAILED DESCRIPTION OF THE EMBODIMENTS

For a better understanding of the disclosure, various aspects of the disclosure will be described in greater detail with reference to the accompanying drawings. It should be understood that these detailed descriptions are merely descriptive of exemplary implementation mode of the disclosure and are not intended to limit the scope of the disclosure in any way. Same reference numerals refer to same elements throughout the specification. The expression “and/or” includes one or more of any and all combinations of associated listed items.

It should be noted that throughout this specification, the recitations of first, second, third, etc. are used merely to distinguish one feature from another and do not represent any limitation on the feature. Thus, the first lens discussed below may also be referred to as the second lens or the third lens without departing from the teachings of the disclosure.

In the accompanying drawings, the thickness, size, and shape of the lens have been slightly exaggerated for ease of illustration. Specifically, a spherical or aspheric shape, shown in the accompanying drawings, is illustrated by way of example. That is to say that the spherical or aspheric shape is not limited to the spherical or aspheric shape shown in the accompanying drawings. The drawings are examples only and are not drawn to scale strictly.

A paraxial region refers herein to a region near an optical axis. If a surface of a lens is a convex surface and a position of the convex surface is not defined, the surface of the lens is a convex surface at least in the paraxial region; and if the surface of the lens is a concave surface and the position of the concave surface is not defined, the surface of the lens is a concave surface at least in the paraxial region. A surface, closest to a shot object, of each lens is called the object-side surface of the lens, and a surface, closest to an imaging surface, of each lens is called the image-side surface of the lens.

It should also be understood that the terms, “comprises”, “comprising”, “has”, “includes”, and/or “including” when used in this specification, indicate the presence of stated features, elements, and/or components, but do not preclude the presence or addition of one or more other features, elements, components, and/or combinations thereof. Further, when a statement such as “at least one of . . . ” appears after a list of listed features, the entire listed feature is modified, rather than modifying an individual element in the list. Further, when describing implementation modes of the disclosure, the use of “may” means “one or more implementation modes of the disclosure”. In addition, the term “exemplary” is intended to refer to an example, or illustration.

All terms (including technical and scientific terms) used herein have the same meaning as commonly understood by those of ordinary skill in the art to which this disclosure belongs unless otherwise defined. It should also be understood that terms (for example, terms defined in commonly used dictionaries) should be interpreted as having a meaning that is consistent with their meaning in the context of the relevant art and will not be interpreted in an idealized or overly formalized sense unless expressly so defined herein.

It should be noted that the embodiments of the disclosure and the features of the embodiments may be combined with each other without conflict. The disclosure will be described in detail below with reference to the accompanying drawings in conjunction with embodiments.

The features, principles, and other aspects of the disclosure are described in detail below.

The optical imaging lens assembly according to an exemplary implementation mode of the disclosure may include seven lenses having refractive powers, which are a first lens, a second lens, a third lens, a fourth lens, a fifth lens, a sixth lens and a seventh lens. The seven lenses are sequentially arranged from an object side to an image side along an optical axis. A spacing distance may be provided between any two adjacent lenses from the first lens to the seventh lens.

In the exemplary implementation mode, the optical imaging lens assembly may also include at least one diaphragm. The diaphragm may be arranged at an appropriate position as desired, for example, arranged between the object side and the first lens.

In the exemplary implementation mode, the first lens may have a positive refractive power or a negative refractive power; the second lens may have a negative refractive power; the third lens may have a positive refractive or a negative refractive power; the fourth lens may have a negative refractive power; the fifth lens may have a negative refractive power; the sixth lens may have a positive refractive or a negative refractive power; and the seventh lens may have a positive refractive power or a negative refractive power. By reasonably distributing the positive and negative refractive powers of each lens of the optical imaging lens assembly, the effect of long-distance photographing may be effectively improved. In addition, the second lens, the fourth lens and the fifth lens have negative refractive powers, such that a spherical aberration and a chromatic aberration generated by the lens group may be effectively balanced so as to improve imaging quality, thereby presenting a clear image on a photosensitive element.

In the exemplary implementation mode, an object-side surface of the sixth lens may be a concave surface, and an image-side surface may be a convex surface. By reasonably configuring a shape of the sixth lens, the sixth lens is not prone to deform in an assembling process to a certain extent, a larger debugging space may be guaranteed, and stray light caused by appearance defects of the sixth lens is avoided.

In the exemplary implementation mode, the optical imaging lens assembly may satisfy TTL/f<1, where f is a total effective focal length of the optical imaging lens assembly, and TTL is a distance from an object-side surface of the first lens to an imaging surface along the optical axis. The optical imaging lens assembly satisfies TTL/f<1, and the optical imaging lens assembly may have capabilities of small depth of field, special visual angle, blurring and perspective. More particularly, TTL and f may satisfy: 0<TTL/f<1.

In the exemplary implementation mode, the optical imaging lens assembly may satisfy 8 mm<ImgH/tan(Semi-FOV), wherein ImgH is a half of a diagonal length of an effective pixel region on the imaging surface, and Semi-FOV is a half of a maximum field of view of the optical imaging lens assembly. The optical imaging lens assembly satisfies 8 mm<ImgH/tan(Semi-FOV), which is beneficial for guaranteeing a larger image surface and a long-focus feature of the optical imaging lens assembly. More particularly, 8 mm<ImgH/tan(Semi-F0V)<10 mm.

In the exemplary implementation mode, the optical imaging lens assembly may satisfy 2.5<TTL/f/tan(Semi-FOV), wherein f is the total effective focal length of the optical imaging lens assembly, TTL is the distance from the object-side surface of the first lens to the imaging surface along the optical axis, and Semi-FOV is a half of the maximum field of view of the optical imaging lens assembly. The optical imaging lens assembly satisfies 2.5<TTL/f/tan(Semi-FOV), which is beneficial to miniaturization and portability of the optical lens and may balance an aberration of the optical lens, so as to present a clear and complete image on the photosensitive element, and achieve a better photographing effect. More specifically, TTL, f and tan(Semi-FOV) may satisfy: 2.5<TTL/f/tan(Semi-F0V)<3.

In the exemplary implementation mode, the optical imaging lens assembly may satisfy 0.5<tan(Semi-FOV)*Fno<1, where Semi-FOV is a half of the maximum field of view of the optical imaging lens assembly, and Fno is an f number of the optical imaging lens assembly. The optical imaging lens assembly satisfies 0.5<tan(Semi-FOV)*Fno<1, which is beneficial to features of large aperture and long focus and an effect of dark scene photographing of the optical lens.

In the exemplary implementation mode, the optical imaging lens assembly may satisfy 1<EPD/ImgH<1.5, wherein EPD is an entrance pupil diameter of the optical imaging lens assembly, and ImgH is a half of the diagonal length of the effective pixel region the imaging surface. The optical imaging lens assembly satisfies 1<EPD/ImgH<1.5, which is beneficial to a large image surface of the imaging lens, and improving the imaging quality.

In the implementation mode, the optical imaging lens assembly satisfies (f1+f2+f3)/f123<1, wherein f1 is an effective focal length of the first lens, f2 is an effective focal length of the second lens, f3 is an effective focal length of the third lens, and f123 is a combined focal length of the first lens, the second lens, and the third lens. The optical imaging lens assembly satisfies (f1+f2+f3)/f123<1, which is beneficial to improving the imaging quality of the optical imaging lens assembly and obtain good resolution. More specifically, f1, f2, f3, and f123 may satisfy: 0<(f1+f2+f3)/f123<1.

In the exemplary implementation mode, the optical imaging lens assembly may satisfy f123/f<0.5, wherein f is the total effective focal length of the optical imaging lens assembly, and f123 is the combined focal length of the first lens, the second lens, and the third lens. The optical imaging lens assembly satisfies f123/f<0.5, which is beneficial to reducing total reflection of light rays and ghost image risk of a surface of the optical imaging lens assembly, and the refractive powers remaining lenses have a larger selection range. More particularly, f123 and f may satisfy: 0<f123/f<0.5.

In the exemplary implementation mode, the optical imaging lens assembly may satisfy −2<(f4+f5)/f<0, wherein f is the total effective focal length of the optical imaging lens assembly, f4 is an effective focal length of the fourth lens, and f5 is an effective focal length of the fifth lens. The optical imaging lens assembly satisfies −2<(f4+f5)/f<0, which is beneficial to the aberration of the optical lens, so as to improve the imaging quality of the optical lens; and moreover, a light trend may be reasonably controlled to avoid too high sensitivity, and meanwhile, the miniaturization of an optical system is facilitated.

In the exemplary implementation mode, the optical imaging lens assembly may satisfy 2.5<TD/(CT7+T67)<3, wherein TD is a distance from an object-side surface of the first lens to an image-side surface of the seventh lens along the optical axis, CT7 is a center thickness of the seventh lens, and T67 is a spacing distance between the sixth lens and the seventh lens along the optical axis. The optical imaging lens assembly satisfies 2.5<TD/(CT7+−T67)<3, which is beneficial to reducing the ghost image risk and the sensitivity of the lens, and reducing a coma aberration and astigmatism of the system, so as to stabilize field curvature and a peak value of a modulation transfer function (MTF).

In the exemplary implementation mode, the optical imaging lens assembly may satisfy (T12+T23+T34)/T45<1, wherein T12 is a spacing distance between the first lens and the second lens along the optical axis, T23 is a spacing distance between the second lens and the third lens along the optical axis, T34 is a spacing distance between the third lens and the fourth lens along the optical axis, and T45 is a spacing distance between the fourth lens and the fifth lens along the optical axis. The optical imaging lens assembly satisfies (T12+T23+T34)/T45<1, which may effectively avoid interference, adjust the field curvature of the optical imaging lens assembly, and weaken ghost image energy between the first lens and the fifth lens. More specifically, T12, T23, T34, and T45 may satisfy: 0<(T12+T23+T34)/T45<1.

In the exemplary implementation mode, the optical imaging lens assembly may satisfy 1<T67/(T45+T56)<2, wherein T45 is the spacing distance between the fourth lens and the fifth lens along the optical axis, T56 is a spacing distance between the fifth lens and the sixth lens along the optical axis, and T67 is a spacing distance between the sixth lens and the seventh lens along the optical axis. The optical imaging lens assembly satisfies 1<T67/(T45+T56)<2, which is beneficial to counteracting positive and negative spherical aberrations, positive and negative astigmatism, positive and negative distortion and a chromatic aberration, and has desirable temperature drift performance.

In the exemplary implementation mode, the optical imaging lens assembly may satisfy 1.5<Nmin, wherein Nmin is a minimum value of refractive indexes of the first lens to the seventh lens. The optical imaging lens assembly satisfies 1.5<Nmin, which is beneficial to miniaturization and portability of the optical imaging lens assembly, and further beneficial to torsion resistance, high-altitude falling and roller testing. More particularly, 1.5<N min<1.7.

In the exemplary implementation mode, the optical imaging lens assembly may satisfy 2<V5/V6<3, wherein V5 is an Abbe number of the fifth lens, and V6 is an Abbe number of the sixth lens. The optical imaging lens assembly satisfies 2<V5/V6<3, which is beneficial to improving the imaging quality and preventing rainbow lines.

In the exemplary implementation mode, the optical imaging lens assembly may satisfy 1<f4/R7<2, wherein f4 is the effective focal length of the fourth lens, and R7 is a curvature radius of an object-side surface of the fourth lens. The optical imaging lens assembly satisfies 1<f4/R7<2, which is beneficial to balancing the distortion and the field curvature of the optical imaging lens assembly, and guarantees that the optical imaging lens assembly has a long-focus feature and high aberration correction capability.

In the exemplary implementation mode, the optical imaging lens assembly may satisfy 2<f/R10−f/R9<3, wherein f is the total effective focal length of the optical imaging lens assembly, R9 is a curvature radius of an object-side surface of the fifth lens, and R10 is a curvature radius of an image-side surface of the fifth lens. The optical imaging lens assembly satisfies 2<f/R10−f/R9<3, such that the optical imaging lens assembly has better imaging quality.

In the exemplary implementation mode, the optical imaging lens assembly may further include an optical filter used for correcting color deviation. And the optical imaging lens assembly may further include a protective glass used for protecting a photosensitive element located on the imaging surface.

The optical imaging lens assembly according to the above implementation mode of the disclosure may employ a plurality of lenses, for example, seven lenses described above. The refractive power and a surface type of each lens, the center thickness of each lens, the on-axis distance between the lenses, etc. are reasonably distributed, thereby effectively reducing a size of the optical imaging lens assembly, reducing sensitivity of the lens, and improving machinability of the lens, which makes the optical imaging lens assembly more beneficial to production and processing and suitable for portable electronic products. The optical imaging lens assembly according to the implementation mode of the disclosure also achieves long-distance photographing while meeting an imaging requirement.

In the implementation mode of the disclosure, at least one of the mirror surfaces of each lens is an aspheric mirror surface, that is, at least one mirror surface from the object-side surface of the first lens to the image-side surface of the seventh lens is an aspheric mirror surface. The aspheric lens is characterized in that the curvature is continuously changed from a center of the lens to a periphery of the lens. Different from a spherical lens with a constant curvature from the center of the lens to the periphery of the lens, the aspheric lens has a better feature of a radius of curvature and has the advantages of improving distortion aberration and astigmatism aberration. After the aspheric lens is used, aberration occurring during imaging may be eliminated as much as possible, thereby improving the imaging quality. Optionally, at least one of the object-side surface and the image-side surface of each of the first lens, the second lens, the third lens, the fourth lens, the fifth lens, the sixth lens and the seventh lens is an aspheric mirror surface. Optionally, the object-side surface and the image-side surface of each of the first lens, the second lens, the third lens, the fourth lens, the fifth lens, the sixth lens and the seventh lens are aspheric mirror surfaces.

However, it should be understood by those skilled in the art that the number of lenses constituting the optical imaging lens assembly may be varied to obtain various results and advantages described in this specification without departing from the claimed technical solution of the disclosure. For example, although described with seven lenses as an example in an implementation mode, the optical imaging lens assembly is not limited to including seven lenses. The optical imaging lens assembly may also include other numbers of lenses if desired.

Specific embodiments of the optical imaging lens assembly that may be suitable for use in the above implementation mode are described further below with reference to the drawings.

### Embodiment 1

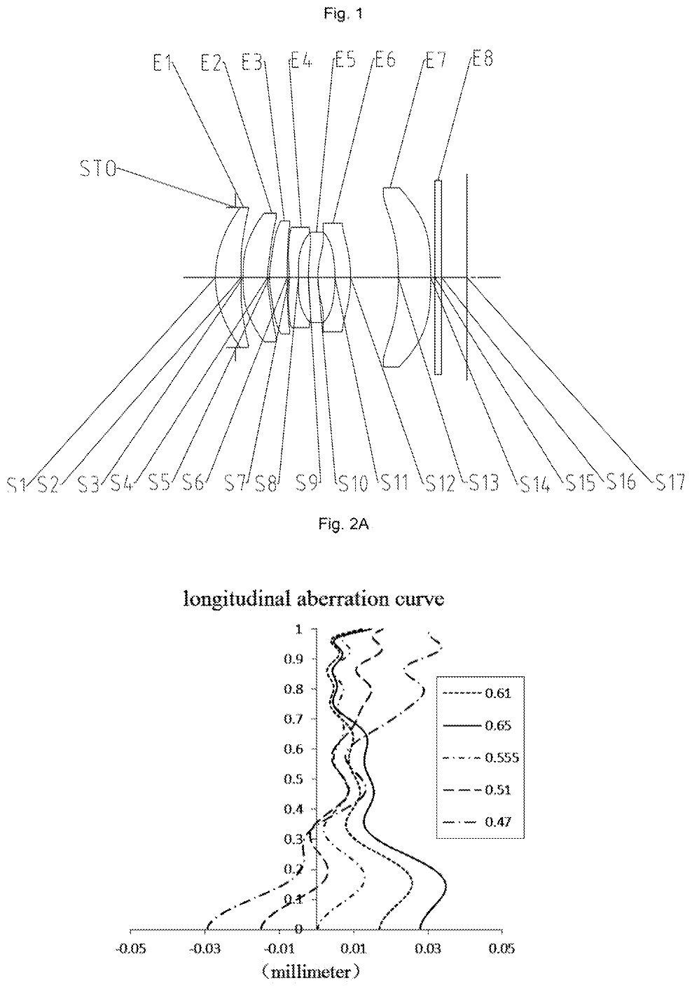

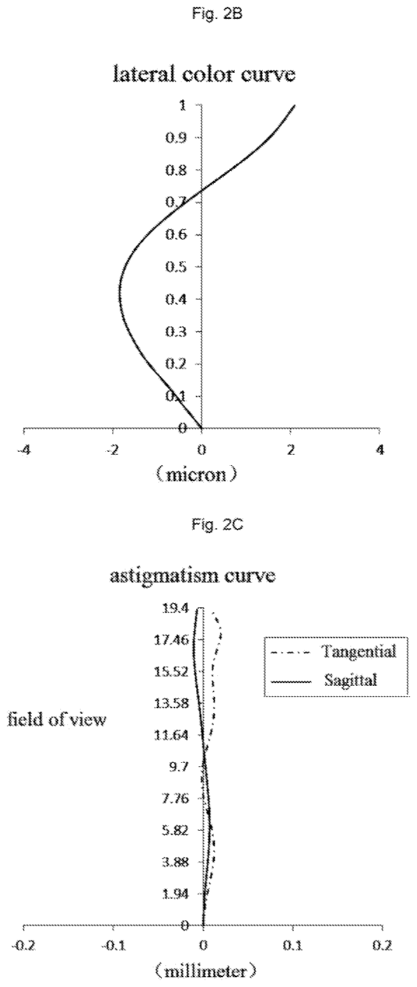

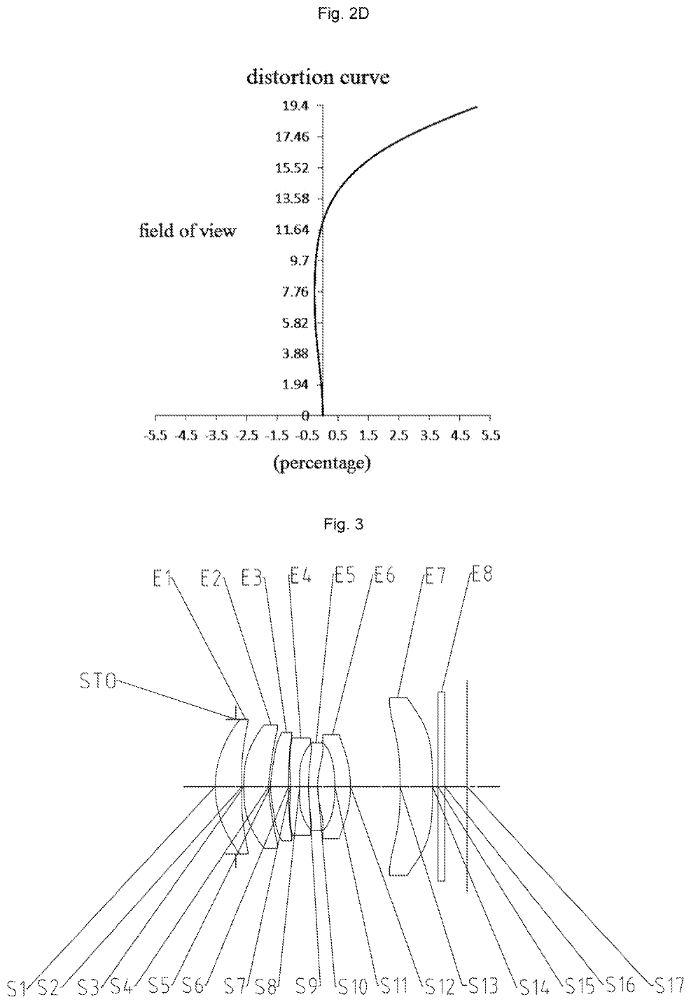

An optical imaging lens assembly according to Embodiment 1 of the disclosure is described below with reference to FIGS. 1-2D. FIG. 1 shows a structural schematic diagram of the optical imaging lens assembly according to Embodiment 1 of the disclosure.

As shown in FIG. 1, the optical imaging lens assembly sequentially includes from an object side to an image side along an optical axis: a diaphragm STO, a first lens E1, a second lens E2, a third lens E3, a fourth lens E4, a fifth lens E5, a sixth lens E6, a seventh lens E7 and an optical filter E8.

The first lens E1 has a positive refractive power, an object-side surface S1 thereof is a convex surface, and an image-side surface S2 thereof is a convex surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a concave surface, and an image-side surface S8 thereof is a convex surface. The fifth lens E5 has a negative refractive power, an object-side surface S9 thereof is a convex surface, and an image-side surface S10 thereof is a concave surface. The sixth lens E6 has a positive refractive power, an object-side surface S11 thereof is a concave surface, and an image-side surface S12 thereof is a convex surface. The seventh lens E7 has a negative refractive power, an object-side surface S13 thereof is a concave surface, and an image-side surface S14 thereof is a convex surface. The optical filter E8 has an object-side surface S15 and an image-side surface S16. The optical imaging lens assembly is provided with an imaging surface S17, and light from an object sequentially passes through each face from S1 to S16 and is finally imaged on the imaging surface S17.

Table 1 illustrates a table of basic parameters of the optical imaging lens assembly of Embodiment 1, wherein the units of the curvature radius, thickness/distance, and focal length are all millimeters (mm).

TABLE 1

| | | | | Material | | | |
|---|---|---|---|---|---|---|---|
| Surface | | Curvature | Thickness/ | Refractive | Abbe | Focal | Conic |
| number | Surface type | radius | distance | index | number | length | coefficient |
| OBJ | Spherical | Infinity | Infinity | | | | |
| STO | Spherical | Infinity | −0.3161 | | | | |
| S1 | Aspheric | 2.8708 | 0.7956 | 1.54 | 56.10 | 4.46 | 0.0036 |
| S2 | Aspheric | −14.5645 | 0.0600 | | | | −2.0449 |
| S3 | Aspheric | 7.9262 | 0.7540 | 1.54 | 56.10 | −5.72 | −0.7408 |
| S4 | Aspheric | 2.1650 | 0.0602 | | | | 0.0033 |
| S5 | Aspheric | 2.0023 | 0.5511 | 1.54 | 56.10 | 4.20 | −0.0024 |
| S6 | Aspheric | 14.1617 | 0.0600 | | | | −3.0190 |
| S7 | Aspheric | −4.7207 | 0.2887 | 1.67 | 19.20 | −8.87 | −0.0302 |
| S8 | Aspheric | −22.5861 | 0.3077 | | | | 98.0000 |
| S9 | Aspheric | 7.4452 | 0.2882 | 1.54 | 56.10 | −6.23 | −5.3364 |
| S10 | Aspheric | 2.3022 | 0.5319 | | | | 0.0452 |
| S11 | Aspheric | −4.1805 | 0.4836 | 1.61 | 25.90 | 36.62 | −0.7129 |
| S12 | Aspheric | −3.6855 | 1.4768 | | | | 0.9645 |
| S13 | Aspheric | −9.0584 | 1.0000 | 1.67 | 19.20 | −31.84 | −0.3648 |
| S14 | Aspheric | −16.3214 | 0.1257 | | | | −97.1660 |
| S15 | Spherical | Infinity | 0.2100 | 1.52 | 64.20 | | |
| S16 | Spherical | Infinity | 0.7829 | | | | |
| S17 | Spherical | Infinity | | | | | |

In Embodiment 1, f, a total effective focal length of the optical imaging lens assembly is 8.14 mm, f123, a combined focal length of the first lens, the second lens, and the third lens is 3.64 mm, Semi-FOV, a half of a maximum field of view of the optical imaging lens assembly is 19.325° and Nmin, a minimum refractive index of all lenses in the optical imaging lens assembly is 1.55.

In Embodiment 1, both of the object-side surface and the image-side surface of any one of the first lens E1 to the seventh lens E7 are Aspheric surfaces, and the surface type x of each aspheric lens may be defined by, but is not limited to, the following aspheric formula:

$$x = \frac{c {h}^{2}}{1 + \sqrt{1 - ( k + 1 ) {c}^{2} {h}^{2}}} + \sum {Aih}^{i} \qquad ( 1 )$$

wherein x is a vector height of a distance between the aspheric surface and a vertex of the aspheric surface when the aspheric surface is located at a position with the height h in the optical axis direction; c is a paraxial curvature of the aspheric surface, c=1/R (that is, the paraxial curvature c is an inverse of curvature radius R in Table 1 above); k is a Conic coefficient; and Ai is a correction coefficient of the i-th order of the aspheric surface. Table 2 below gives higher order term coefficients A₄, A₆, A₈, A₁₀, A₁₂, A₁₄, A₁₆, A₁₈ and A₂₀ that may be used for each of the aspheric mirror surfaces S1-S14 in Embodiment 1.

TABLE 2

| Surface | | | | | |
|---|---|---|---|---|---|
| number | A4 | A6 | A8 | A10 | A12 |
| S1 | −3.8957E−03 | 1.6504E−04 | 2.6913E−03 | −2.3153E−03 | 2.8710E−04 |
| S2 | 8.4072E−02 | −2.4615E−03 | −1.7370E−02 | −1.0009E−02 | 2.0245E−02 |
| S3 | 7.4380E−02 | 4.1052E−02 | −7.7212E−02 | 5.2872E−02 | −2.9302E−02 |
| S4 | −2.4809E−01 | 2.1855E−01 | −2.2137E−01 | 3.3031E−01 | −4.0168E−01 |
| S5 | −2.1615E−01 | 1.2396E−01 | −2.6614E−01 | 6.6180E−01 | −8.4702E−01 |
| S6 | −1.2648E−01 | 7.9075E−01 | −3.6423E+00 | 9.9656E+00 | −1.6433E+01 |
| S7 | −5.0683E−03 | 1.0576E+00 | −4.3287E+00 | 1.0753E+01 | −1.7268E+01 |
| S8 | 1.6967E−01 | 3.9448E−01 | −1.2410E+00 | 1.8045E+00 | −1.5648E+00 |
| S9 | 2.8348E−02 | 2.6794E−01 | −1.7259E+00 | 5.6234E+00 | −1.2529E+01 |
| S10 | −2.8143E−02 | −8.6701E−03 | 4.7338E−02 | −1.0223E+00 | 3.7327E+00 |
| S11 | −2.0227E−02 | 6.0497E−02 | −3.4343E−01 | 1.0369E+00 | −2.0087E+00 |
| S12 | −7.0755E−03 | 6.2526E−02 | −2.0306E−01 | 4.4535E−01 | −6.4706E−01 |
| S13 | −2.7819E−02 | 2.1518E−02 | −1.9122E−02 | 1.2566E−02 | −5.7036E−03 |
| S14 | −4.3160E−02 | 1.9792E−02 | −1.3100E−02 | 6.8182E−03 | −2.6809E−03 |

| Surface | | | | |
|---|---|---|---|---|
| number | A14 | A16 | A18 | A20 |
| S1 | 3.7991E−04 | −2.0573E−04 | 4.6031E−05 | −4.9855E−06 |
| S2 | −1.1572E−02 | 3.4789E−03 | −5.9688E−04 | 5.5431E−05 |
| S3 | 1.5614E−02 | −6.3515E−03 | 1.6119E−03 | −2.2200E−04 |
| S4 | 3.1135E−01 | −1.5268E−01 | 4.7555E−02 | −9.1422E−03 |
| S5 | 6.2271E−01 | −2.8117E−01 | 7.9092E−02 | −1.3459E−02 |
| S6 | 1.7073E+01 | −1.1456E+01 | 4.9607E+00 | −1.3399E+00 |
| S7 | 1.8067E+01 | −1.2375E+01 | 5.4977E+00 | −1.5250E+00 |
| S8 | 5.0567E−01 | 5.6220E−01 | −7.6348E−01 | 3.5794E−01 |
| S9 | 1.9186E+01 | −1.9985E+01 | 1.3915E+01 | −6.2079E+00 |
| S10 | −7.2147E+00 | 8.5843E+00 | −6.4676E+00 | 3.0047E+00 |
| S11 | 2.4410E+00 | −1.8620E+00 | 8.6534E−01 | −2.2332E−01 |
| S12 | 6.3099E−01 | −4.1458E−01 | 1.8204E−01 | −5.1370E−02 |
| S13 | 1.7858E−03 | −3.7981E−04 | 5.3560E−05 | −4.7886E−06 |
| S14 | 8.0032E−04 | −1.7925E−04 | 2.9250E−05 | −3.3196E−06 |

FIG. 2A illustrates a longitudinal aberration curve of the optical imaging lens assembly in Embodiment 1, which represents that a convergence focus of light rays of different wavelengths is deviated after the light rays pass through the lens. FIG. 2B illustrates a lateral color curve of the optical imaging lens assembly in Embodiment 1, which represents a deviation of different image heights of the light rays on the imaging surface after the light rays pass through the lens. FIG. 2C illustrates an astigmatism curve of the optical imaging lens assembly of Embodiment 1, which represents a curvature of tangential image surface and a curvature of sagittal image surface. FIG. 2D illustrates a distortion curve of the optical imaging lens assembly of Embodiment 1, which represents distortion magnitude values corresponding to different fields of view. FIGS. 2A-2D illustrate that the optical imaging lens assembly given in Embodiment 1 is capable of achieving good imaging quality.

### Embodiment 2

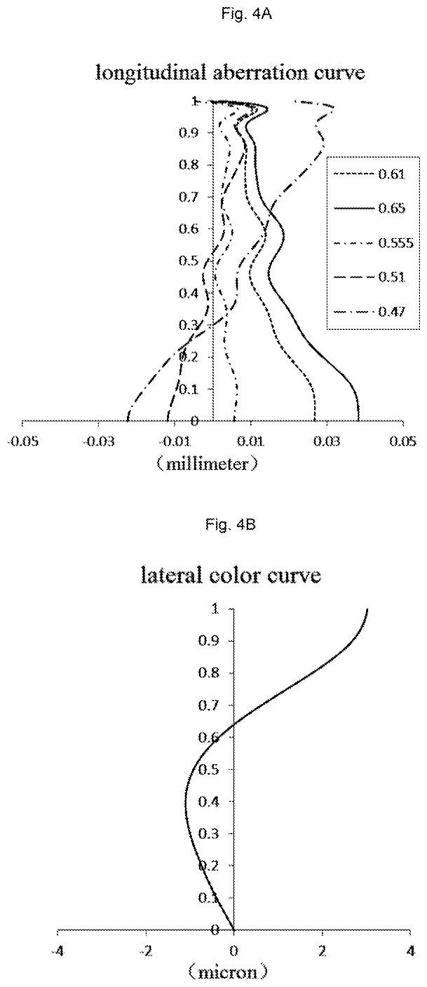

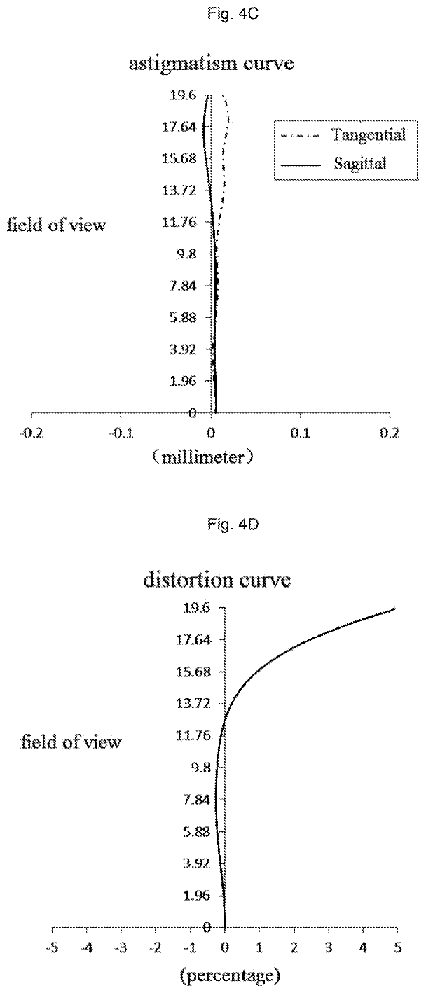

An optical imaging lens assembly according to Embodiment 2 of the disclosure is described below with reference to FIGS. 3-4D. In this and the following examples, part of the description similar to Embodiment 1 will be omitted for the sake of brevity. FIG. 3 shows a structural schematic diagram of the optical imaging lens assembly according to Embodiment 2 of the disclosure.

As shown in FIG. 3, the optical imaging lens assembly sequentially includes from an object side to an image side along an optical axis: a diaphragm STO, a first lens E1, a second lens E2, a third lens E3, a fourth lens E4, a fifth lens E5, a sixth lens E6, a seventh lens E7 and an optical filter E8.

The first lens E1 has a positive refractive power, an object-side surface S1 thereof is a convex surface, and an image-side surface S2 thereof is a convex surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a concave surface, and an image-side surface S8 thereof is a convex surface. The fifth lens E5 has a negative refractive power, an object-side surface S9 thereof is a convex surface, and an image-side surface S10 thereof is a concave surface. The sixth lens E6 has a positive refractive power, an object-side surface S11 thereof is a concave surface, and an image-side surface S12 thereof is a convex surface. The seventh lens E7 has a negative refractive power, an object-side surface S13 thereof is a concave surface, and an image-side surface S14 thereof is a concave surface. The optical filter E8 has an object-side surface S15 and an image-side surface S16. The optical imaging lens assembly is provided with an imaging surface S17, and light from an object sequentially passes through each face from S1 to S16 and is finally imaged on the imaging surface S17.

In Embodiment 2, f, a total effective focal length of the optical imaging lens assembly is 8.04 mm, f123, a combined focal length of the first lens, the second lens, and the third lens is 3.67 mm, Semi-FOV, a half of a maximum field of view of the optical imaging lens assembly is 19.325°, and Nmin, a minimum refractive index of all lenses in the optical imaging lens assembly is 1.55.

Table 3 illustrates a table of basic parameters of the optical imaging lens assembly of Embodiment 2, wherein the units of the curvature radius, thickness/distance, and focal length are all millimeters (mm). Table 4 illustrates high order term coefficients applicable to various aspheric mirror surfaces in Embodiment 2, wherein types of various aspheric surfaces may be defined by the formula (1) provided in above-mentioned Embodiment 1.

TABLE 3

| | | | | Material | | | |
|---|---|---|---|---|---|---|---|
| Surface | | Curvature | Thickness/ | Refractive | Abbe | Focal | Conic |
| number | Surface type | radius | distance | index | number | length | coefficient |
| OBJ | Spherical | Infinity | Infinity | | | | |
| STO | Spherical | Infinity | −0.5515 | | | | |
| S1 | Aspheric | 2.8739 | 0.8267 | 1.54 | 56.10 | 4.38 | 0.0206 |
| S2 | Aspheric | −12.7236 | 0.0600 | | | | 0.0000 |
| S3 | Aspheric | 8.2613 | 0.7678 | 1.54 | 56.10 | −5.59 | −0.6054 |
| S4 | Aspheric | 2.1565 | 0.0600 | | | | 0.0000 |
| S5 | Aspheric | 1.9903 | 0.5567 | 1.54 | 56.10 | 4.29 | −0.0045 |
| S6 | Aspheric | 11.8759 | 0.0600 | | | | 0.0000 |
| S7 | Aspheric | −4.9815 | 0.2832 | 1.67 | 19.20 | −8.66 | 0.9278 |
| S8 | Aspheric | −34.0148 | 0.2729 | | | | 0.0000 |
| S9 | Aspheric | 9.1915 | 0.2833 | 1.54 | 56.10 | −5.79 | 0.5516 |
| S10 | Aspheric | 2.3254 | 0.5360 | | | | 0.0000 |
| S11 | Aspheric | −4.1279 | 0.4835 | 1.61 | 25.90 | 20.70 | −1.2211 |
| S12 | Aspheric | −3.2620 | 1.5357 | | | | 0.0000 |
| S13 | Aspheric | −17.9524 | 1.0000 | 1.67 | 19.20 | −25.82 | 1.5582 |
| S14 | Aspheric | 672.7513 | 0.1743 | | | | 0.0000 |
| S15 | Spherical | Infinity | 0.2100 | 1.52 | 64.20 | | |
| S16 | Spherical | Infinity | 0.6900 | | | | |
| S17 | Spherical | Infinity | | | | | |

TABLE 4

| Surface | | | | | | | |
|---|---|---|---|---|---|---|---|
| number | A4 | A6 | A8 | A10 | A12 | A14 | A16 |
| S1 | −3.6730E−03 | 2.3630E−03 | −2.1015E−03 | 1.0146E−03 | −3.1676E−04 | 5.1884E−05 | −3.3022E−06 |
| S2 | 1.0768E−01 | −6.0683E−02 | 2.4749E−02 | −9.2417E−03 | 2.8291E−03 | −5.8212E−04 | 6.9747E−05 |
| S3 | 1.0421E−01 | −4.1995E−02 | 1.1022E−02 | −1.1057E−03 | −9.4948E−04 | 4.3069E−04 | −5.1000E−05 |
| S4 | −2.3663E−01 | 1.5240E−01 | −1.2433E−02 | −5.7125E−02 | 4.1895E−02 | −1.3628E−02 | 2.1876E−03 |
| S5 | −2.1449E−01 | 6.1361E−02 | 3.9697E−02 | 5.7851E−02 | −3.1647E−01 | 6.2240E−01 | −8.1978E−01 |
| S6 | −9.5762E−02 | 1.5100E−01 | 1.5674E−01 | −9.5315E−01 | 1.6034E+00 | −1.4566E+00 | 7.9288E−01 |
| S7 | 2.4812E−02 | 4.8600E−01 | −9.6960E−01 | 8.6430E−01 | −3.4877E−01 | −7.4973E−03 | 6.5255E−02 |
| S8 | 1.7976E−01 | 2.6290E−01 | 7.7223E−03 | −5.5127E+00 | 2.6720E+01 | −7.5532E+01 | 1.4640E+02 |
| S9 | 5.3405E−02 | −1.7412E−02 | 2.3682E−01 | −2.8802E+00 | 1.1546E+01 | −2.7433E+01 | 4.3864E+01 |
| S10 | −1.9464E−02 | −6.4927E−02 | 1.6970E−01 | −1.0313E+00 | 3.0638E+00 | −5.3432E+00 | 5.9395E+00 |
| S11 | −7.7954E−03 | −5.1728E−02 | 1.7839E−01 | −4.6804E−01 | 7.0719E−01 | −6.7220E−01 | 3.9115E−01 |
| S12 | 1.8257E−03 | 2.8099E−03 | −5.1862E−03 | 1.2749E−02 | −2.0064E−02 | 1.6528E−02 | −6.1826E−03 |
| S13 | −2.3803E−02 | 1.2168E−02 | −7.1874E−03 | 3.2970E−03 | −1.0527E−03 | 2.3052E−04 | −3.2137E−05 |
| S14 | −3.7935E−02 | 1.1951E−02 | −4.9374E−03 | 1.4533E−03 | −2.7703E−04 | 3.2768E−05 | −2.1149E−06 |
| Surface | | | | | | | |
| number | A18 | A20 | A22 | A24 | A26 | A28 | A30 |
| S1 | 0.0000E+00 | 0.0000E+00 | 0.0000E+00 | 0.0000E+00 | 0.0000E+00 | 0.0000E+00 | 0.0000E+00 |
| S2 | −3.7116E−06 | 0.0000E+00 | 0.0000E+00 | 0.0000E+00 | 0.0000E+00 | 0.0000E+00 | 0.0000E+00 |
| S3 | 0.0000E+00 | 0.0000E+00 | 0.0000E+00 | 0.0000E+00 | 0.0000E+00 | 0.0000E+00 | 0.0000E+00 |
| S4 | −1.4107E−04 | 0.0000E+00 | 0.0000E+00 | 0.0000E+00 | 0.0000E+00 | 0.0000E+00 | 0.0000E+00 |
| S5 | 7.7195E−01 | −5.1797E−01 | 2.4391E−01 | −7.8488E−02 | 1.6405E−02 | −2.0043E−03 | 1.0850E−04 |
| S6 | −2.5877E−01 | 4.6720E−02 | −3.5871E−03 | 0.0000E+00 | 0.0000E+00 | 0.0000E+00 | 0.0000E+00 |
| S7 | −2.3960E−02 | 2.8981E−03 | 0.0000E+00 | 0.0000E+00 | 0.0000E+00 | 0.0000E+00 | 0.0000E+00 |
| S8 | −2.0229E+02 | 2.0094E+02 | −1.4230E+02 | 7.0052E+01 | −2.2762E+01 | 4.3865E+00 | −3.7952E−01 |
| S9 | −4.9219E+01 | 3.9222E+01 | −2.2033E+01 | 8.4872E+00 | −2.1166E+00 | 3.0401E−01 | −1.8716E−02 |
| S10 | −4.2655E+00 | 1.9184E+00 | −4.9192E−01 | 5.4941E−02 | 0.0000E+00 | 0.0000E+00 | 0.0000E+00 |
| S11 | −1.2509E−01 | 1.6604E−02 | 0.0000E+00 | 0.0000E+00 | 0.0000E+00 | 0.0000E+00 | 0.0000E+00 |
| S12 | 9.2549E−04 | −2.9210E−05 | 0.0000E+00 | 0.0000E+00 | 0.0000E+00 | 0.0000E+00 | 0.0000E+00 |
| S13 | 2.5195E−06 | −8.3968E−08 | 0.0000E+00 | 0.0000E+00 | 0.0000E+00 | 0.0000E+00 | 0.0000E+00 |
| S14 | 5.5132E−08 | 0.0000E+00 | 0.0000E+00 | 0.0000E+00 | 0.0000E+00 | 0.0000E+00 | 0.0000E+00 |

FIG. 4A illustrates a longitudinal aberration curve of the optical imaging lens assembly in Embodiment 2, which represents that a convergence focus of light rays of different wavelengths is deviated after the light rays pass through the lens. FIG. 4B illustrates a lateral color curve of the optical imaging lens assembly in Embodiment 2, which represents a deviation of different image heights of the light rays on the imaging surface after the light rays pass through the lens. FIG. 4C illustrates an astigmatism curve of the optical imaging lens assembly of Embodiment 2, which represents a curvature of tangential image surface and a curvature of sagittal image surface. FIG. 4D illustrates a distortion curve of the optical imaging lens assembly of Embodiment 2, which represents distortion magnitude values corresponding to different fields of view. FIGS. 4A-4D illustrate that the optical imaging lens assembly given in Embodiment 2 is capable of achieving good imaging quality.

### Embodiment 3

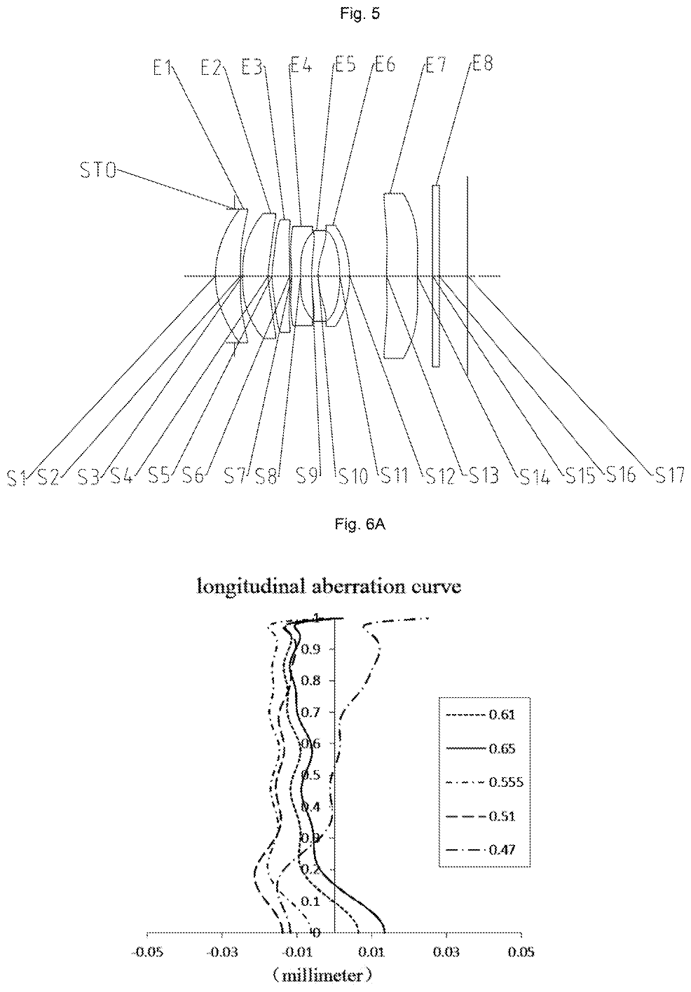

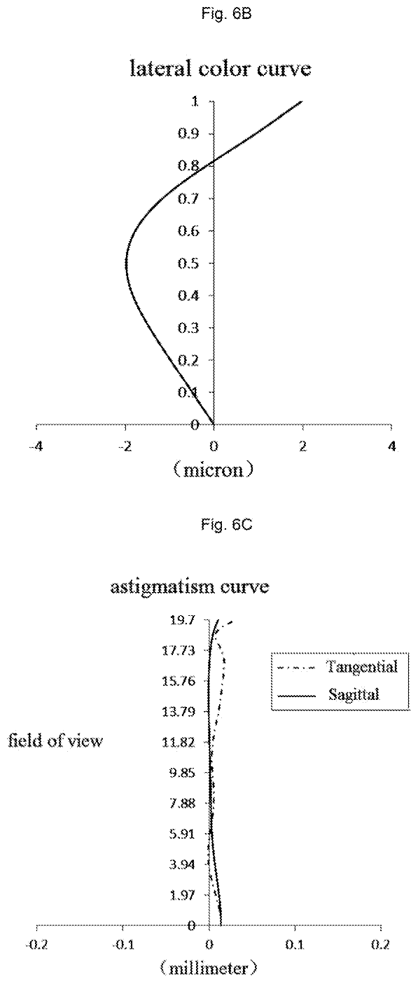

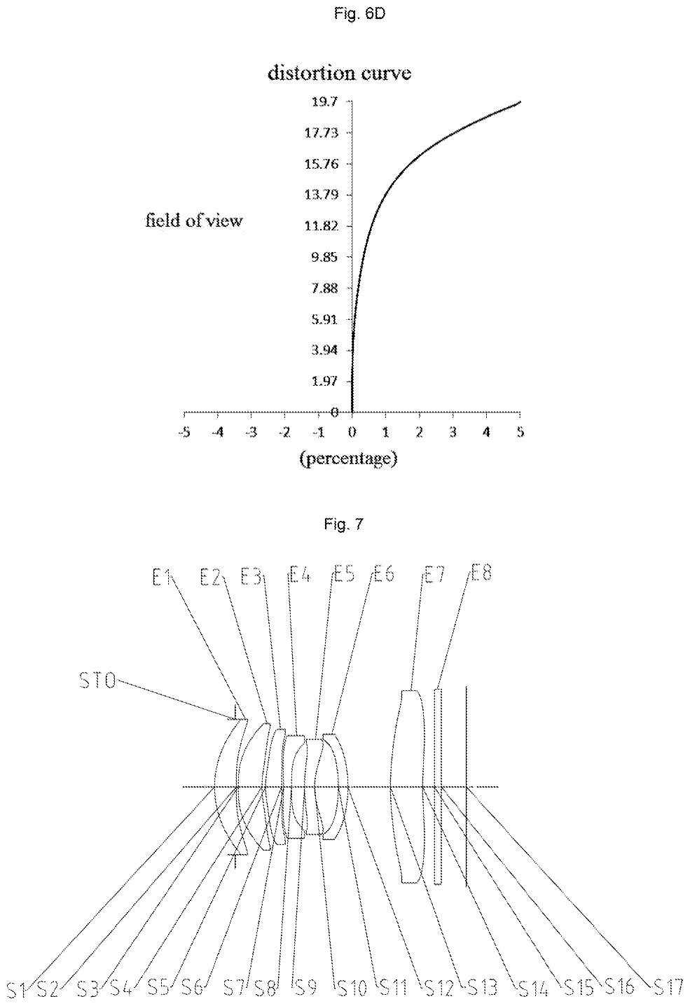

An optical imaging lens assembly according to Embodiment 3 of the disclosure is described below with reference to FIGS. 5-6D. FIG. 5 shows a structural schematic diagram of the optical imaging lens assembly according to Embodiment 3 of the disclosure.

As shown in FIG. 5, the optical imaging lens assembly sequentially includes from an object side to an image side along an optical axis: a diaphragm STO, a first lens E1, a second lens E2, a third lens E3, a fourth lens E4, a fifth lens E5, a sixth lens E6, a seventh lens E7 and an optical filter E8.

The first lens E1 has a positive refractive power, an object-side surface S1 thereof is a convex surface, and an image-side surface S2 thereof is a convex surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a convex surface. The fourth lens E4 has a negative refractive power, an object-side surface S7 thereof is a concave surface, and an image-side surface S8 thereof is a convex surface. The fifth lens E5 has a negative refractive power, an object-side surface S9 thereof is a convex surface, and an image-side surface S10 thereof is a concave surface. The sixth lens E6 has a positive refractive power, an object-side surface S11 thereof is a concave surface, and an image-side surface S12 thereof is a convex surface. The seventh lens E7 has a positive refractive power, an object-side surface S13 thereof is a convex surface, and an image-side surface S14 thereof is a concave surface. The optical filter E8 has an object-side surface S15 and an image-side surface S16. The optical imaging lens assembly is provided with an imaging surface S17, and light from an object sequentially passes through each face from S1 to S16 and is finally imaged on the imaging surface S17.

In Embodiment 3, f, a total effective focal length of the optical imaging lens assembly is 8.00 mm, f123, a combined focal length of the first lens, the second lens, and the third lens is 3.43 mm, Semi-FOV, a half of a maximum field of view of the optical imaging lens assembly is 19.325°, and Nmin, a minimum refractive index of all lenses in the optical imaging lens assembly is 1.55.

Table 5 illustrates a table of basic parameters of the optical imaging lens assembly of Embodiment 3, wherein the units of the curvature radius, thickness/distance, and focal length are all millimeters (mm). Table 6 illustrates high order term coefficients applicable to various aspheric mirror surfaces in Embodiment 3, wherein types of various aspheric surfaces may be defined by the formula (1) provided in above-mentioned Embodiment 1.

TABLE 5

| | | | | Material | | | |
|---|---|---|---|---|---|---|---|
| Surface | | Curvature | Thickness/ | Refractive | Abbe | Focal | Conic |
| number | Surface type | radius | distance | index | number | length | coefficient |
| OBJ | Spherical | Infinity | Infinity | | | | |
| STO | Spherical | Infinity | −0.6341 | | | | |
| S1 | Aspheric | 2.8668 | 0.7802 | 1.54 | 56.10 | 4.44 | 0.0037 |
| S2 | Aspheric | −14.2792 | 0.0620 | | | | 0.0000 |
| S3 | Aspheric | 8.5285 | 0.7920 | 1.54 | 56.10 | −5.93 | −1.2795 |
| S4 | Aspheric | 2.2708 | 0.1165 | | | | 0.0000 |
| S5 | Aspheric | 2.1625 | 0.5493 | 1.54 | 56.10 | 3.88 | −0.0144 |
| S6 | Aspheric | −100.0300 | 0.0600 | | | | 0.0000 |
| S7 | Aspheric | −4.0681 | 0.2768 | 1.67 | 19.20 | −6.42 | −0.3468 |
| S8 | Aspheric | −64.6692 | 0.3389 | | | | 0.0000 |
| S9 | Aspheric | 5.4151 | 0.2000 | 1.54 | 56.10 | −5.66 | −12.2752 |
| S10 | Aspheric | 1.9408 | 0.6706 | | | | 0.0000 |
| S11 | Aspheric | −3.9651 | 0.3010 | 1.61 | 25.90 | 29.39 | −2.6220 |
| S12 | Aspheric | −3.3498 | 1.1481 | | | | 0.0000 |
| S13 | Aspheric | 15.7426 | 0.9505 | 1.67 | 19.20 | 277.41 | −98.0000 |
| S14 | Aspheric | 16.7642 | 0.4669 | | | | 0.0000 |
| S15 | Spherical | Infinity | 0.2103 | 1.52 | 64.20 | | |
| S16 | Spherical | Infinity | 0.8768 | | | | |
| S17 | Spherical | Infinity | | | | | |

TABLE 6

| Surface | | | | | | | |
|---|---|---|---|---|---|---|---|
| number | A4 | A6 | A8 | A10 | A12 | A14 | A16 |
| S1 | −2.3871E−03 | 1.3861E−03 | −2.4307E−03 | 2.3166E−03 | −1.4261E−03 | 5.3877E−04 | −1.2774E−04 |
| S2 | 1.2567E−01 | −1.0124E−01 | 6.9532E−02 | −3.8969E−02 | 1.5879E−02 | −4.4763E−03 | 8.3540E−04 |
| S3 | 1.1981E−01 | −8.3825E−02 | 5.7451E−02 | −3.5035E−02 | 1.6996E−02 | −6.2306E−03 | 1.5787E−03 |
| S4 | −2.3770E−01 | 2.4001E−01 | −2.3423E−01 | 1.8753E−01 | −1.0699E−01 | 3.9313E−02 | −8.4196E−03 |
| S5 | −2.4917E−01 | 2.0475E−01 | −2.5612E−01 | 5.3110E−01 | −1.0399E+00 | 1.5549E+00 | −1.6951E+00 |
| S6 | −1.0845E−01 | 2.6434E−01 | −2.9802E−01 | 7.1842E−02 | 2.4269E−01 | −3.3932E−01 | 2.1431E−01 |
| S7 | 1.1529E−01 | 1.4885E−01 | −4.5789E−01 | 5.2811E−01 | −3.3014E−01 | 1.0513E−01 | −7.2857E−03 |
| S8 | 2.2970E−01 | −1.2105E−02 | −4.4348E−01 | 1.0781E+00 | −9.1743E−01 | −2.5141E+00 | 1.1184E+01 |
| S9 | 6.6573E−02 | −3.5115E−01 | 2.0036E+00 | −1.0410E+01 | 3.8035E+01 | −9.7549E+01 | 1.7906E+02 |
| S10 | −1.9042E−02 | −1.4656E−01 | 3.2370E−01 | −7.6468E−01 | 1.4185E+00 | −1.8552E+00 | 1.6690E+00 |
| S11 | −9.5613E−03 | −2.2662E−02 | 7.8378E−02 | −2.3395E−01 | 3.7000E−01 | −3.6361E−01 | 2.1574E−01 |
| S12 | −3.5199E−03 | 8.7190E−03 | −8.8435E−03 | 8.9075E−04 | 2.6954E−03 | −3.8723E−03 | 2.8712E−03 |
| S13 | −2.6537E−02 | 1.0039E−02 | −4.6517E−03 | 2.1935E−03 | −7.6250E−04 | 1.7944E−04 | −2.6423E−05 |
| S14 | −3.1978E−02 | 7.7593E−03 | −2.7939E−03 | 9.0623E−04 | −2.1027E−04 | 3.1634E−05 | −2.6609E−06 |
| Surface | | | | | | | |
| number | A18 | A20 | A22 | A24 | A26 | A28 | A30 |
| S1 | 1.7882E−05 | −1.1268E−06 | 0.0000E+00 | 0.0000E+00 | 0.0000E+00 | 0.0000E+00 | 0.0000E+00 |
| S2 | −9.2560E−05 | 4.5251E−06 | 0.0000E+00 | 0.0000E+00 | 0.0000E+00 | 0.0000E+00 | 0.0000E+00 |
| S3 | −2.3381E−04 | 1.4672E−05 | 0.0000E+00 | 0.0000E+00 | 0.0000E+00 | 0.0000E+00 | 0.0000E+00 |
| S4 | 8.7536E−04 | −2.5120E−05 | 0.0000E+00 | 0.0000E+00 | 0.0000E+00 | 0.0000E+00 | 0.0000E+00 |
| S5 | 1.3366E+00 | −7.6004E−01 | 3.0843E−01 | −8.7048E−02 | 1.6216E−02 | −1.7904E−03 | 8.8620E−05 |
| S6 | −7.3854E−02 | 1.3327E−02 | −9.7809E−04 | 0.0000E+00 | 0.0000E+00 | 0.0000E+00 | 0.0000E+00 |
| S7 | −4.5595E−03 | 8.9994E−04 | 0.0000E+00 | 0.0000E+00 | 0.0000E+00 | 0.0000E+00 | 0.0000E+00 |
| S8 | −2.1907E+01 | 2.6824E+01 | −2.1945E+01 | 1.2038E+01 | −4.2649E+00 | 8.8404E−01 | −8.1575E−02 |
| S9 | −2.3796E+02 | 2.2923E+02 | −1.5841E+02 | 7.6508E+01 | −2.4508E+01 | 4.6771E+00 | −4.0241E−01 |
| S10 | −1.0098E+00 | 3.9150E−01 | −8.7769E−02 | 8.6617E−03 | 0.0000E+00 | 0.0000E+00 | 0.0000E+00 |
| S11 | −7.0232E−02 | 9.5800E−03 | 0.0000E+00 | 0.0000E+00 | 0.0000E+00 | 0.0000E+00 | 0.0000E+00 |
| S12 | −8.9286E−04 | 9.3661E−05 | 0.0000E+00 | 0.0000E+00 | 0.0000E+00 | 0.0000E+00 | 0.0000E+00 |
| S13 | 2.1538E−06 | −7.3567E−08 | 0.0000E+00 | 0.0000E+00 | 0.0000E+00 | 0.0000E+00 | 0.0000E+00 |
| S14 | 9.2216E−08 | 0.0000E+00 | 0.0000E+00 | 0.0000E+00 | 0.0000E+00 | 0.0000E+00 | 0.0000E+00 |

FIG. 6A illustrates a longitudinal aberration curve of the optical imaging lens assembly in Embodiment 3, which represents that a convergence focus of light rays of different wavelengths is deviated after the light rays pass through the lens. FIG. 6B illustrates a lateral color curve of the optical imaging lens assembly in Embodiment 3, which represents a deviation of different image heights of the light rays on the imaging surface after the light rays pass through the lens. FIG. 6C illustrates an astigmatism curve of the optical imaging lens assembly of Embodiment 3, which represents a curvature of tangential image surface and a curvature of sagittal image surface. FIG. 6D illustrates a distortion curve of the optical imaging lens assembly of Embodiment 3, which represents distortion magnitude values corresponding to different fields of view. FIGS. 6A-6D illustrate that the optical imaging lens assembly given in Embodiment 3 is capable of achieving good imaging quality.

### Embodiment 4

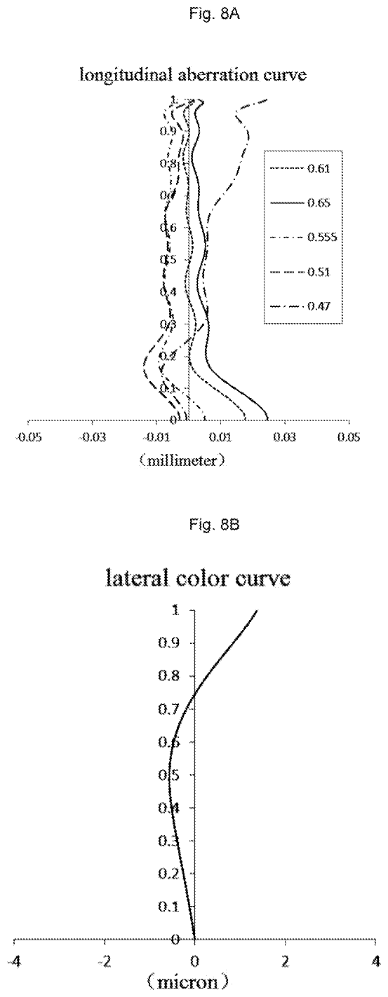

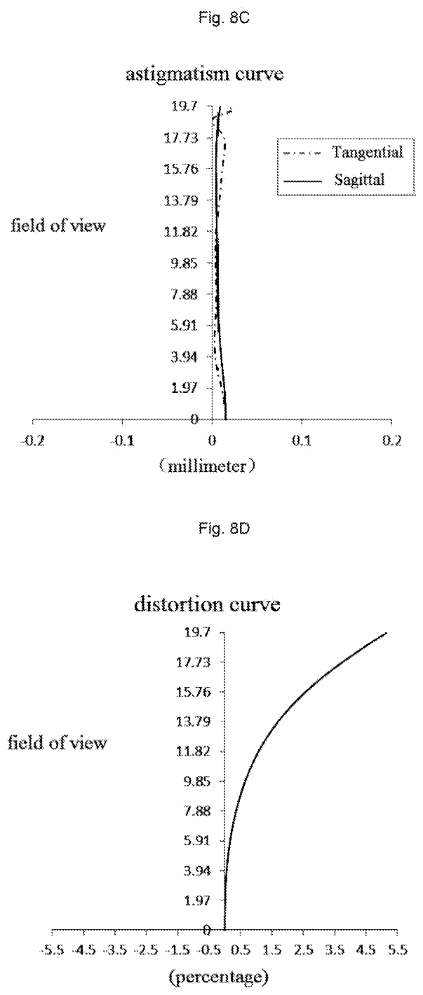

An optical imaging lens assembly according to Embodiment 4 of the disclosure is described below with reference to FIGS. 7-8D. FIG. 7 shows a structural schematic diagram of the optical imaging lens assembly according to Embodiment 4 of the disclosure.

As shown in FIG. 7, the optical imaging lens assembly sequentially includes from an object side to an image side along an optical axis: a diaphragm STO, a first lens E1, a second lens E2, a third lens E3, a fourth lens E4, a fifth lens E5, a sixth lens E6, a seventh lens E7 and an optical filter E8.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a concave surface, and an image-side surface S8 thereof is a concave surface. The fifth lens E5 has a negative refractive power, an object-side surface S9 thereof is a convex surface, and an image-side surface S10 thereof is a concave surface. The sixth lens E6 has a positive refractive power, an object-side surface S11 thereof is a concave surface, and an image-side surface S12 thereof is a convex surface. The seventh lens E7 has a positive refractive power, an object-side surface S13 thereof is a convex surface, and an image-side surface S14 thereof is a concave surface. The optical filter E8 has an object-side surface S15 and an image-side surface S16. The optical imaging lens assembly is provided with an imaging surface S17, and light from an object sequentially passes through each face from S1 to S16 and is finally imaged on the imaging surface S17.

In Embodiment 4, f, a total effective focal length of the optical imaging lens assembly is 8.00 mm, f123, a combined focal length of the first lens, the second lens, and the third lens is 3.56 mm, Semi-FOV, a half of a maximum field of view of the optical imaging lens assembly is 19.325°, and Nmin, a minimum refractive index of all lenses in the optical imaging lens assembly is 1.55.

Table 7 illustrates a table of basic parameters of the optical imaging lens assembly of Embodiment 4, wherein the units of the curvature radius, thickness/distance, and focal length are all millimeters (mm). Table 8 illustrates high order term coefficients applicable to various aspheric mirror surfaces in Embodiment 4, wherein types of various aspheric surfaces may be defined by the formula (1) provided in above-mentioned Embodiment 1.

TABLE 7

| | | | | Material | | | |
|---|---|---|---|---|---|---|---|
| Surface | | Curvature | Thickness/ | Refractive | Abbe | Focal | Conic |
| number | Surface type | radius | distance | index | number | length | coefficient |
| OBJ | Spherical | Infinity | Infinity | | | | |
| STO | Spherical | Infinity | −0.6388 | | | | |
| S1 | Aspheric | 2.7675 | 0.6730 | 1.54 | 56.10 | 5.12 | 0.0448 |
| S2 | Aspheric | 265.2896 | 0.0600 | | | | 0.0000 |
| S3 | Aspheric | 5.3636 | 0.7329 | 1.54 | 56.10 | −7.69 | −0.2474 |
| S4 | Aspheric | 2.2412 | 0.1116 | | | | 0.0000 |
| S5 | Aspheric | 2.0673 | 0.5018 | 1.54 | 56.10 | 4.21 | −0.0091 |
| S6 | Aspheric | 18.6872 | 0.0600 | | | | 0.0000 |
| S7 | Aspheric | −4.8726 | 0.2444 | 1.67 | 19.20 | −6.95 | −0.4476 |
| S8 | Aspheric | 141.4665 | 0.4039 | | | | 0.0000 |
| S9 | Aspheric | 4.5370 | 0.3113 | 1.54 | 56.10 | −6.15 | −16.7551 |
| S10 | Aspheric | 1.8819 | 0.7368 | | | | 0.0000 |
| S11 | Aspheric | −3.9262 | 0.2958 | 1.61 | 25.90 | 89.73 | −3.9578 |
| S12 | Aspheric | −3.7725 | 1.3154 | | | | 0.0000 |
| S13 | Aspheric | 6.6561 | 1.0000 | 1.67 | 19.20 | 42.69 | −0.6734 |
| S14 | Aspheric | 8.1237 | 0.3658 | | | | 0.0000 |
| S15 | Spherical | Infinity | 0.2103 | 1.52 | 64.20 | | |
| S16 | Spherical | Infinity | 0.7771 | | | | |
| S17 | Spherical | Infinity | | | | | |

TABLE 8

| Surface | | | | | | | |
|---|---|---|---|---|---|---|---|
| number | A4 | A6 | A8 | A10 | A12 | A14 | A16 |
| S1 | −1.4834E−03 | 2.1887E−03 | −2.2853E−03 | 1.0892E−03 | −5.3126E−04 | 2.3599E−04 | −6.8185E−05 |
| S2 | 1.1344E−01 | −5.2531E−02 | −4.6828E−03 | 1.9582E−02 | −1.1783E−02 | 3.8335E−03 | −7.4291E−04 |
| S3 | 1.0570E−01 | −2.8939E−02 | −2.6720E−02 | 3.3559E−02 | −1.7167E−02 | 4.9788E−03 | −8.4054E−04 |
| S4 | −2.4122E−01 | 2.7070E−01 | −3.0117E−01 | 2.5962E−01 | −1.5453E−01 | 6.0259E−02 | −1.4605E−02 |
| S5 | −2.4525E−01 | 1.8829E−01 | −1.2108E−01 | −1.3500E−02 | 2.2814E−01 | −3.7490E−01 | 3.4569E−01 |
| S6 | −9.2552E−02 | 1.9114E−01 | −1.6221E−01 | −3.4729E−02 | 2.4312E−01 | −2.7744E−01 | 1.6712E−01 |
| S7 | 1.2865E−01 | 9.1514E−02 | −3.5466E−01 | 4.3230E−01 | −2.9916E−01 | 1.2677E−01 | −3.1535E−02 |
| S8 | 2.1824E−01 | −5.0140E−03 | −4.5848E−01 | 1.2121E+00 | −1.5788E+00 | −7.4783E−01 | 8.3561E+00 |
| S9 | 1.5382E−02 | −1.7514E−01 | 1.4137E+00 | −8.3246E+00 | 3.2276E+01 | −8.6090E+01 | 1.6271E+02 |
| S10 | −7.0432E−02 | −4.9985E−03 | 4.6736E−02 | −2.2985E−01 | 5.7160E−01 | −8.7400E−01 | 8.6576E−01 |
| S11 | −2.9394E−02 | 3.2100E−02 | −7.7619E−02 | 1.2481E−01 | −1.4005E−01 | 9.1428E−02 | −3.1474E−02 |
| S12 | −1.2044E−02 | 3.6302E−02 | −7.6101E−02 | 1.2606E−01 | −1.4174E−01 | 9.9689E−02 | −4.2346E−02 |
| S13 | −1.7449E−02 | 6.3051E−03 | −1.5460E−03 | 3.1316E−04 | −5.5262E−05 | 8.3311E−06 | −1.0125E−06 |
| S14 | −2.5559E−02 | 5.7315E−03 | −1.2372E−03 | 2.1407E−04 | −2.3187E−05 | 8.8455E−07 | 6.1200E−08 |

| Surface | | | | | | | |
|---|---|---|---|---|---|---|---|
| number | A18 | A20 | A22 | A24 | A26 | A28 | A30 |
| S1 | 1.0625E−05 | −6.8696E−07 | 0.0000E+00 | 0.0000E+00 | 0.0000E+00 | 0.0000E+00 | 0.0000E+00 |
| S2 | 8.0940E−05 | −3.8484E−06 | 0.0000E+00 | 0.0000E+00 | 0.0000E+00 | 0.0000E+00 | 0.0000E+00 |
| S3 | 7.6666E−05 | −3.0278E−06 | 0.0000E+00 | 0.0000E+00 | 0.0000E+00 | 0.0000E+00 | 0.0000E+00 |
| S4 | 1.9857E−03 | −1.1529E−04 | 0.0000E+00 | 0.0000E+00 | 0.0000E+00 | 0.0000E+00 | 0.0000E+00 |
| S5 | −2.0793E−01 | 8.4400E−02 | −2.2685E−02 | 3.7279E−03 | −2.9090E−04 | −3.5716E−06 | 1.5715E−06 |
| S6 | −5.7844E−02 | 1.0807E−02 | −8.4271E−04 | 0.0000E+00 | 0.0000E+00 | 0.0000E+00 | 0.0000E+00 |
| S7 | 3.9578E−03 | −1.6137E−04 | 0.0000E+00 | 0.0000E+00 | 0.0000E+00 | 0.0000E+00 | 0.0000E+00 |
| S8 | −1.9030E+01 | 2.4926E+01 | −2.1135E+01 | 1.1811E+01 | −4.2165E+00 | 8.7402E−01 | −8.0219E−02 |
| S9 | −2.2117E+02 | 2.1687E+02 | −1.5196E+02 | 7.4184E+01 | −2.3959E+01 | 4.6003E+00 | −3.9756E−01 |
| S10 | −5.5845E−01 | 2.2617E−01 | −5.2195E−02 | 5.2290E−03 | 0.0000E+00 | 0.0000E+00 | 0.0000E+00 |
| S11 | 3.8003E−03 | 2.4156E−04 | 0.0000E+00 | 0.0000E+00 | 0.0000E+00 | 0.0000E+00 | 0.0000E+00 |
| S12 | 9.8967E−03 | −9.6646E−04 | 0.0000E+00 | 0.0000E+00 | 0.0000E+00 | 0.0000E+00 | 0.0000E+00 |
| S13 | 8.2662E−08 | −3.1921E−09 | 0.0000E+00 | 0.0000E+00 | 0.0000E+00 | 0.0000E+00 | 0.0000E+00 |
| S14 | −5.4612E−09 | 0.0000E+00 | 0.0000E+00 | 0.0000E+00 | 0.0000E+00 | 0.0000E+00 | 0.0000E+00 |

FIG. 8A illustrates a longitudinal aberration curve of the optical imaging lens assembly in Embodiment 4, which represents that a convergence focus of light rays of different wavelengths is deviated after the light rays pass through the lens. FIG. 8B illustrates a lateral color curve of the optical imaging lens assembly in Embodiment 4, which represents a deviation of different image heights of the light rays on the imaging surface after the light rays pass through the lens. FIG. 8C illustrates an astigmatism curve of the optical imaging lens assembly of Embodiment 4, which represents a curvature of tangential image surface and a curvature of sagittal image surface. FIG. 8D illustrates a distortion curve of the optical imaging lens assembly of Embodiment 4, which represents distortion magnitude values corresponding to different fields of view. FIGS. 8A-8D illustrate that the optical imaging lens assembly given in Embodiment 4 is capable of achieving good imaging quality.

### Embodiment 5

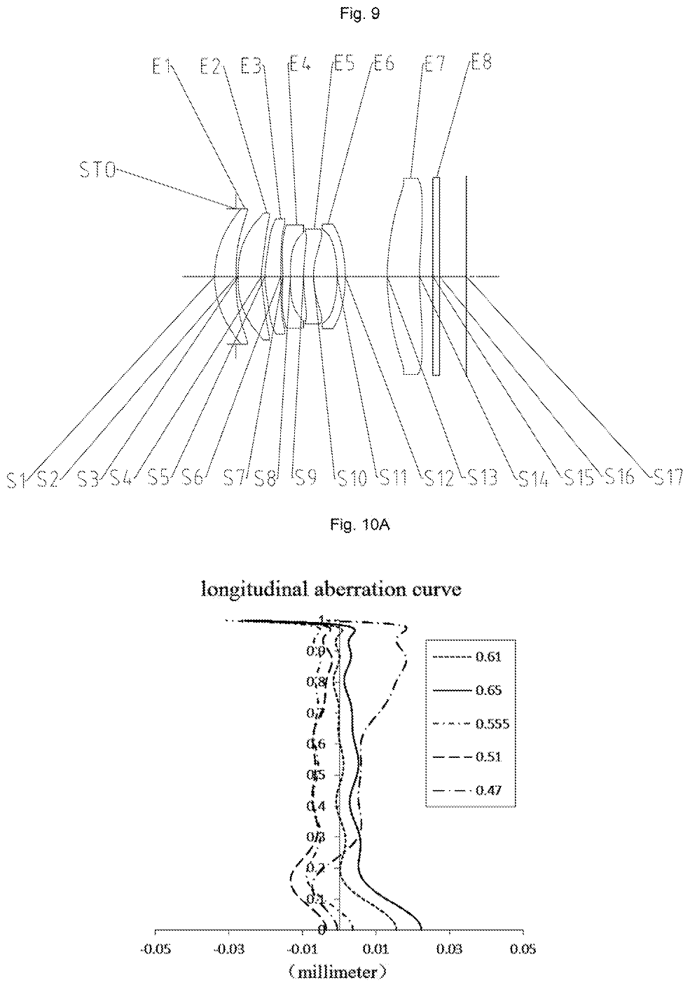

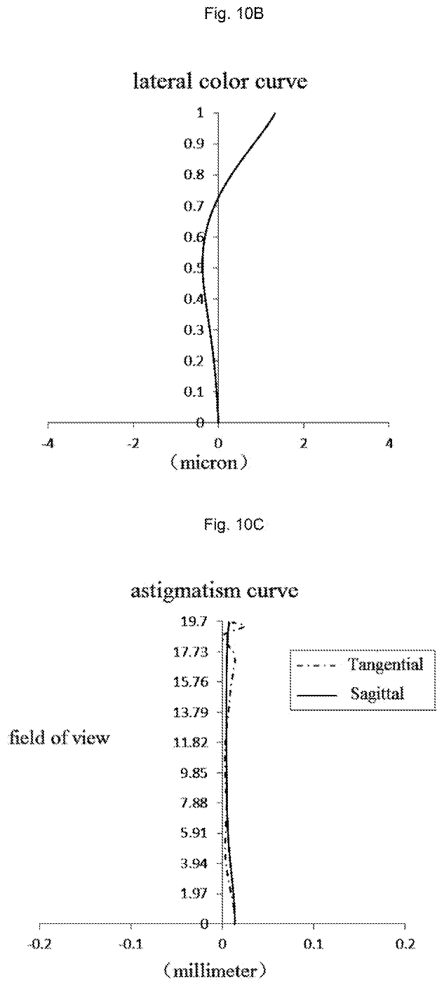

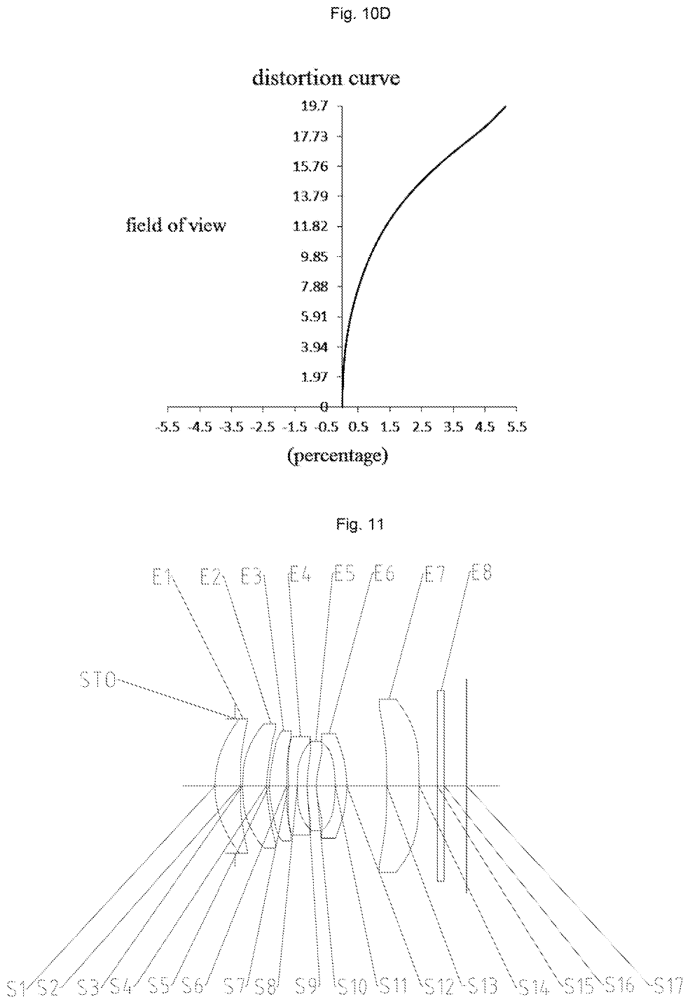

An optical imaging lens assembly according to Embodiment 5 of the disclosure is described below with reference to FIGS. 9-10D. FIG. 9 shows a structural schematic diagram of the optical imaging lens assembly according to Embodiment 5 of the disclosure.

As shown in FIG. 9, the optical imaging lens assembly sequentially includes from an object side to an image side along an optical axis: a diaphragm STO, a first lens E1, a second lens E2, a third lens E3, a fourth lens E4, a fifth lens E5, a sixth lens E6, a seventh lens E7 and an optical filter E8.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a concave surface, and an image-side surface S8 thereof is a concave surface. The fifth lens E5 has a negative refractive power, an object-side surface S9 thereof is a convex surface, and an image-side surface S10 thereof is a concave surface. The sixth lens E6 has a negative refractive power, an object-side surface S11 thereof is a concave surface, and an image-side surface S12 thereof is a convex surface. The seventh lens E7 has a positive refractive power, an object-side surface S13 thereof is a convex surface, and an image-side surface S14 thereof is a concave surface. The optical filter E8 has an object-side surface S15 and an image-side surface S16. The optical imaging lens assembly is provided with an imaging surface S17, and light from an object sequentially passes through each face from S1 to S16 and is finally imaged on the imaging surface S17.

In Embodiment 5, f, a total effective focal length of the optical imaging lens assembly is 8.00 mm, f123, a combined focal length of the first lens, the second lens, and the third lens is 3.56 mm, Semi-FOV, a half of a maximum field of view of the optical imaging lens assembly is 19.325°, and Nmin, a minimum value of refractive indexes of all lenses in the optical imaging lens assembly is 1.55.

Table 9 illustrates a table of basic parameters of the optical imaging lens assembly of Embodiment 5, wherein the units of the curvature radius, thickness/distance, and focal length are all millimeters (mm). Table 10 illustrates high order term coefficients applicable to various aspheric mirror surfaces in Embodiment 5, wherein types of various aspheric surfaces may be defined by the formula (1) provided in above-mentioned Embodiment 1.

TABLE 9

| | | | | Material | | | |
|---|---|---|---|---|---|---|---|
| Surface | | Curvature | Thickness/ | Refractive | Abbe | Focal | Conic |
| number | Surface type | radius | distance | index | number | length | coefficient |
| OBJ | Spherical | Infinity | Infinity | | | | |
| STO | Spherical | Infinity | −0.6475 | | | | |
| S1 | Aspheric | 2.7660 | 0.6651 | 1.54 | 56.10 | 5.16 | 0.0455 |
| S2 | Aspheric | 139.6621 | 0.0600 | | | | 0.0000 |
| S3 | Aspheric | 5.2617 | 0.7212 | 1.54 | 56.10 | −7.82 | −0.1586 |
| S4 | Aspheric | 2.2420 | 0.1100 | | | | 0.0000 |
| S5 | Aspheric | 2.0559 | 0.4969 | 1.54 | 56.10 | 4.22 | −0.0080 |
| S6 | Aspheric | 17.5349 | 0.0604 | | | | 0.0000 |
| S7 | Aspheric | −4.9142 | 0.2360 | 1.67 | 19.20 | −6.93 | −0.6577 |
| S8 | Aspheric | 106.3918 | 0.4053 | | | | 0.0000 |
| S9 | Aspheric | 4.3961 | 0.3044 | 1.54 | 56.10 | −6.38 | −17.4935 |
| S10 | Aspheric | 1.8961 | 0.7413 | | | | 0.0000 |
| S11 | Aspheric | −3.7813 | 0.2489 | 1.61 | 25.90 | −144.46 | −4.4194 |
| S12 | Aspheric | −4.0476 | 1.2986 | | | | 0.0000 |
| S13 | Aspheric | 5.4744 | 1.0000 | 1.67 | 19.20 | 24.48 | −0.5894 |
| S14 | Aspheric | 7.5720 | 0.4152 | | | | 0.0000 |
| S15 | Spherical | Infinity | 0.2103 | 1.52 | 64.20 | | |
| S16 | Spherical | Infinity | 0.8265 | | | | |
| S17 | Spherical | Infinity | | | | | |

TABLE 10

| Surface | | | | | | | |
|---|---|---|---|---|---|---|---|
| number | A4 | A6 | A8 | A10 | A12 | A14 | A16 |
| S1 | −1.4188E−03 | 2.2565E−03 | −2.2188E−03 | 5.9528E−04 | 1.5194E−05 | −4.1537E−05 | 7.1317E−06 |
| S2 | 1.1494E−01 | −5.3837E−02 | −7.7495E−03 | 2.5015E−02 | −1.5550E−02 | 5.2717E−03 | −1.0621E−03 |
| S3 | 1.0740E−01 | −2.9377E−02 | −3.2936E−02 | 4.4274E−02 | −2.5717E−02 | 8.9240E−03 | −1.9201E−03 |
| S4 | −2.4034E−01 | 2.6759E−01 | −2.9340E−01 | 2.4767E−01 | −1.4386E−01 | 5.4681E−02 | −1.2925E−02 |
| S5 | −2.4484E−01 | 1.8444E−01 | −1.1250E−01 | −1.8783E−02 | 2.1571E−01 | −3.4487E−01 | 3.1539E−01 |
| S6 | −8.8518E−02 | 1.7277E−01 | −1.1692E−01 | −1.0575E−01 | 3.1721E−01 | −3.2914E−01 | 1.9093E−01 |
| S7 | 1.3060E−01 | 8.1340E−02 | −3.3422E−01 | 4.1080E−01 | −2.8658E−01 | 1.2375E−01 | −3.2183E−02 |
| S8 | 2.1201E−01 | 1.3644E−02 | −6.2153E−01 | 2.2413E+00 | −5.8068E+00 | 1.1019E+01 | −1.4448E+01 |
| S9 | 6.5221E−03 | −1.4621E−01 | 1.2809E+00 | −7.6894E+00 | 3.0051E+01 | −8.0560E+01 | 1.5286E+02 |
| S10 | −7.6523E−02 | 5.6617E−03 | 5.2690E−02 | −2.8642E−01 | 7.1169E−01 | −1.0831E+00 | 1.0694E+00 |
| S11 | −3.3703E−02 | 3.5449E−02 | −5.7988E−02 | 7.0639E−02 | −6.3877E−02 | 2.5454E−02 | 3.4079E−03 |
| S12 | −1.6078E−02 | 3.9576E−02 | −6.6627E−02 | 1.0429E−01 | −1.1986E−01 | 8.7006E−02 | −3.8184E−02 |
| S13 | −1.7452E−02 | 6.1736E−03 | −1.5786E−03 | 3.6554E−04 | −7.3299E−05 | 1.1080E−05 | −1.1413E−06 |
| S14 | −2.3467E−02 | 5.2720E−03 | −1.2976E−03 | 3.1270E−04 | −5.6640E−05 | 6.4042E−06 | −3.9577E−07 |

| Surface | | | | | | | |
|---|---|---|---|---|---|---|---|
| number | A18 | A20 | A22 | A24 | A26 | A28 | A30 |
| S1 | −2.0214E−08 | −7.0238E−08 | 0.0000E+00 | 0.0000E+00 | 0.0000E+00 | 0.0000E+00 | 0.0000E+00 |
| S2 | 1.1962E−04 | −5.8311E−06 | 0.0000E+00 | 0.0000E+00 | 0.0000E+00 | 0.0000E+00 | 0.0000E+00 |
| S3 | 2.3907E−04 | −1.3360E−05 | 0.0000E+00 | 0.0000E+00 | 0.0000E+00 | 0.0000E+00 | 0.0000E+00 |
| S4 | 1.7167E−03 | −9.7647E−05 | 0.0000E+00 | 0.0000E+00 | 0.0000E+00 | 0.0000E+00 | 0.0000E+00 |
| S5 | −1.9056E−01 | 7.8755E−02 | −2.1984E−02 | 3.9138E−03 | −3.8473E−04 | 1.2101E−05 | 5.8588E−07 |
| S6 | −6.4794E−02 | 1.1976E−02 | −9.2949E−04 | 0.0000E+00 | 0.0000E+00 | 0.0000E+00 | 0.0000E+00 |
| S7 | 4.4781E−03 | −2.4220E−04 | 0.0000E+00 | 0.0000E+00 | 0.0000E+00 | 0.0000E+00 | 0.0000E+00 |
| S8 | 1.2254E+01 | −5.6227E+00 | −4.3411E−02 | 1.7523E+00 | −1.0645E+00 | 2.9019E−01 | −3.1784E−02 |
| S9 | −2.0850E+02 | 2.0506E+02 | −1.4408E+02 | 7.0510E+01 | −2.2822E+01 | 4.3902E+00 | −3.8001E−01 |
| S10 | −6.8823E−01 | 2.7819E−01 | −6.4072E−02 | 6.4037E−03 | 0.0000E+00 | 0.0000E+00 | 0.0000E+00 |
| S11 | −6.5437E−03 | 1.5555E−03 | 0.0000E+00 | 0.0000E+00 | 0.0000E+00 | 0.0000E+00 | 0.0000E+00 |
| S12 | 9.2128E−03 | −9.2589E−04 | 0.0000E+00 | 0.0000E+00 | 0.0000E+00 | 0.0000E+00 | 0.0000E+00 |
| S13 | 7.1732E−08 | −2.1402E−09 | 0.0000E+00 | 0.0000E+00 | 0.0000E+00 | 0.0000E+00 | 0.0000E+00 |
| S14 | 9.7177E−09 | 0.0000E+00 | 0.0000E+00 | 0.0000E+00 | 0.0000E+00 | 0.0000E+00 | 0.0000E+00 |

FIG. 10A illustrates a longitudinal aberration curve of the optical imaging lens assembly in Embodiment 5, which represents that a convergence focus of light rays of different wavelengths is deviated after the light rays pass through the lens. FIG. 10B illustrates a lateral color curve of the optical imaging lens assembly in Embodiment 5, which represents a deviation of different image heights of the light rays on the imaging surface after the light rays pass through the lens. FIG. 10C illustrates an astigmatism curve of the optical imaging lens assembly of Embodiment 5, which represents a curvature of tangential image surface and a curvature of sagittal image surface. FIG. 10D illustrates a distortion curve of the optical imaging lens assembly of Embodiment 5, which represents distortion magnitude values corresponding to different fields of view. FIGS. 10A-10D illustrate that the optical imaging lens assembly given in Embodiment 5 is capable of achieving good imaging quality.

### Embodiment 6

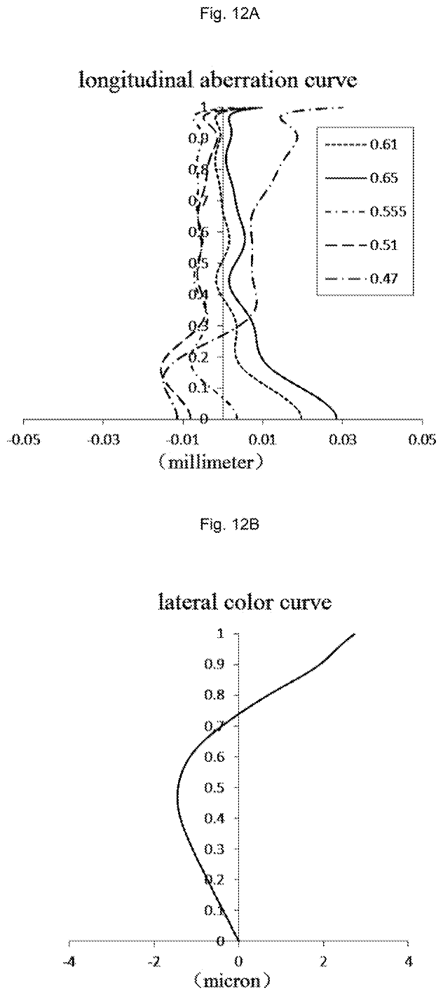

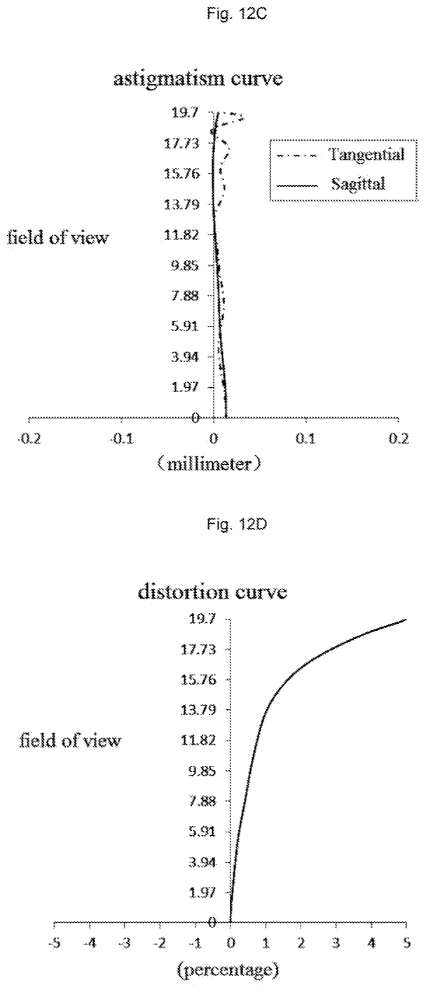

An optical imaging lens assembly according to Embodiment 6 of the disclosure is described below with reference to FIGS. 11-12D. FIG. 11 shows a structural schematic diagram of the optical imaging lens assembly according to Embodiment 6 of the disclosure.

As shown in FIG. 11, the optical imaging lens assembly sequentially includes from an object side to an image side along an optical axis: a diaphragm STO, a first lens E1, a second lens E2, a third lens E3, a fourth lens E4, a fifth lens E5, a sixth lens E6, a seventh lens E7 and an optical filter E8.

The first lens E1 has a positive refractive power, an object-side surface S1 thereof is a convex surface, and an image-side surface S2 thereof is a convex surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a concave surface, and an image-side surface S8 thereof is a concave surface. The fifth lens E5 has a negative refractive power, an object-side surface S9 thereof is a convex surface, and an image-side surface S10 thereof is a concave surface. The sixth lens E6 has a positive refractive power, an object-side surface S11 thereof is a concave surface, and an image-side surface S12 thereof is a convex surface. The seventh lens E7 has a positive refractive power, an object-side surface S13 thereof is a concave surface, and an image-side surface S14 thereof is a convex surface. The optical filter E8 has an object-side surface S15 and an image-side surface S16. The optical imaging lens assembly is provided with an imaging surface S17, and light from an object sequentially passes through each face from S1 to S16 and is finally imaged on the imaging surface S17.

In Embodiment 6, f, a total effective focal length of the optical imaging lens assembly is 8.00 mm, f123, a combined focal length of the first lens, the second lens, and the third lens is 3.76 mm, Semi-FOV, a half of a maximum field of view of the optical imaging lens assembly is 19.325°, and Nmin, a minimum refractive index of all lenses in the optical imaging lens assembly is 1.55.

Table 11 illustrates a table of basic parameters of the optical imaging lens assembly of Embodiment 6, wherein the units of the curvature radius, thickness/distance, and focal length are all millimeters (mm). Table 12 illustrates high order term coefficients applicable to various aspheric mirror surfaces in Embodiment 6, wherein types of various aspheric surfaces may be defined by the formula (1) provided in above-mentioned Embodiment 1.

TABLE 11

| | | | | Material | | | |
|---|---|---|---|---|---|---|---|
| Surface | | Curvature | Thickness/ | Refractive | Abbe | Focal | Conic |
| number | Surface type | radius | distance | index | number | length | coefficient |
| OBJ | Spherical | Infinity | Infinity | | | | |
| STO | Spherical | Infinity | −0.5338 | | | | |
| S1 | Aspheric | 2.8613 | 0.7978 | 1.54 | 56.10 | 4.43 | 0.0174 |
| S2 | Aspheric | −14.1760 | 0.0604 | | | | 2.3927 |
| S3 | Aspheric | 7.3245 | 0.7400 | 1.54 | 56.10 | −5.86 | −0.3737 |
| S4 | Aspheric | 2.1482 | 0.0887 | | | | −0.0004 |
| S5 | Aspheric | 1.9641 | 0.5376 | 1.54 | 56.10 | 4.55 | −0.0026 |
| S6 | Aspheric | 8.4479 | 0.0600 | | | | 13.1190 |
| S7 | Aspheric | −5.6207 | 0.2717 | 1.67 | 19.20 | −7.25 | 0.8335 |
| S8 | Aspheric | 39.5086 | 0.3026 | | | | 29.7878 |
| S9 | Aspheric | 4.8676 | 0.2872 | 1.54 | 56.10 | −7.26 | −9.7919 |
| S10 | Aspheric | 2.1394 | 0.5876 | | | | −0.3815 |
| S11 | Aspheric | −4.1335 | 0.3577 | 1.61 | 25.90 | 33.31 | −0.3479 |
| S12 | Aspheric | −3.5571 | 1.2390 | | | | 1.8439 |
| S13 | Aspheric | −55.0000 | 1.0000 | 1.67 | 19.20 | 351.43 | −19.4500 |
| S14 | Aspheric | −45.0000 | 0.5672 | | | | −98.0000 |
| S15 | Spherical | Infinity | 0.2100 | 1.52 | 64.20 | | |
| S16 | Spherical | Infinity | 0.6925 | | | | |
| S17 | Spherical | Infinity | | | | | |

TABLE 12

| Surface | | | | | | | |
|---|---|---|---|---|---|---|---|
| number | A4 | A6 | A8 | A10 | A12 | A14 | A16 |
| S1 | −2.7477E−03 | −4.1471E−04 | 3.8120E−03 | −5.7587E−03 | 4.5077E−03 | −2.2032E−03 | 6.8651E−04 |
| S2 | 1.0637E−01 | −4.0540E−02 | −1.9641E−02 | 4.0359E−02 | −3.0197E−02 | 1.3311E−02 | −3.6855E−03 |
| S3 | 9.5889E−02 | −3.5816E−03 | −6.9967E−02 | 8.9782E−02 | −6.3862E−02 | 2.9462E−02 | −9.2003E−03 |
| S4 | −2.6290E−01 | 3.5009E−01 | −5.0413E−01 | 5.6740E−01 | −4.2919E−01 | 2.0941E−01 | −6.4475E−02 |
| S5 | −2.4591E−01 | 2.2650E−01 | −1.5458E−01 | −2.9898E−01 | 1.2373E+00 | −2.0677E+00 | 2.1373E+00 |
| S6 | −1.0105E−01 | 8.9293E−02 | 4.0550E−01 | −1.2689E+00 | 1.6491E+00 | −1.1573E+00 | 4.3678E−01 |
| S7 | 1.0626E−01 | 5.8688E−02 | 4.4258E−02 | −5.4421E−01 | 8.6866E−01 | −6.3377E−01 | 2.1682E−01 |
| S8 | 2.6351E−01 | −1.8092E−01 | 9.6516E−01 | −6.9384E+00 | 2.9071E+01 | −8.0693E+01 | 1.5708E+02 |
| S9 | 1.0832E−01 | −5.3908E−01 | 2.8626E+00 | −1.4335E+01 | 5.1809E+01 | −1.3292E+02 | 2.4568E+02 |
| S10 | 3.3806E−03 | −2.4622E−01 | 6.1511E−01 | −1.5936E+00 | 3.2357E+00 | −4.6157E+00 | 4.5053E+00 |
| S11 | 5.1651E−03 | −6.3317E−03 | −1.2610E−01 | 3.0782E−01 | −4.8665E−01 | 4.9120E−01 | −3.1377E−01 |
| S12 | 1.2228E−02 | 1.5141E−02 | −9.6012E−02 | 1.9300E−01 | −2.4498E−01 | 2.0336E−01 | −1.0772E−01 |
| S13 | −1.3690E−02 | 4.6723E−03 | −6.6409E−03 | 6.5650E−03 | −4.0344E−03 | 1.5973E−03 | −4.0292E−04 |
| S14 | −1.7147E−02 | −1.2742E−02 | 3.6845E−02 | −5.8250E−02 | 5.8517E−02 | −3.9624E−02 | 1.8723E−02 |

| Surface | | | | | | | |
|---|---|---|---|---|---|---|---|
| number | A18 | A20 | A22 | A24 | A26 | A28 | A30 |
| S1 | −1.3348E−04 | 1.4912E−05 | −7.3550E−07 | 0.0000E+00 | 0.0000E+00 | 0.0000E+00 | 0.0000E+00 |
| S2 | 6.3279E−04 | −6.1794E−05 | 2.6218E−06 | 0.0000E+00 | 0.0000E+00 | 0.0000E+00 | 0.0000E+00 |
| S3 | 1.9124E−03 | −2.3847E−04 | 1.3280E−05 | 0.0000E+00 | 0.0000E+00 | 0.0000E+00 | 0.0000E+00 |
| S4 | 1.2001E−02 | −1.2241E−03 | 5.2297E−05 | 0.0000E+00 | 0.0000E+00 | 0.0000E+00 | 0.0000E+00 |
| S5 | −1.5089E+00 | 7.5071E−01 | −2.6314E−01 | 6.3404E−02 | −9.9472E−03 | 9.0979E−04 | −3.6572E−05 |
| S6 | −6.8777E−02 | −3.9974E−03 | 1.9001E−03 | 0.0000E+00 | 0.0000E+00 | 0.0000E+00 | 0.0000E+00 |
| S7 | −1.4238E−02 | −1.0721E−02 | 2.1297E−03 | 0.0000E+00 | 0.0000E+00 | 0.0000E+00 | 0.0000E+00 |
| S8 | −2.1882E+02 | 2.1901E+02 | −1.5606E+02 | 7.7211E+01 | −2.5195E+01 | 4.8738E+00 | −4.2325E−01 |
| S9 | −3.3009E+02 | 3.2230E+02 | −2.2608E+02 | 1.1090E+02 | −3.6086E+01 | 6.9925E+00 | −6.1047E−01 |
| S10 | −2.9452E+00 | 1.2310E+00 | −2.9708E−01 | 3.1477E−02 | 0.0000E+00 | 0.0000E+00 | 0.0000E+00 |
| S11 | 1.2399E−01 | −2.8147E−02 | 2.8595E−03 | 0.0000E+00 | 0.0000E+00 | 0.0000E+00 | 0.0000E+00 |
| S12 | 3.5294E−02 | −6.5518E−03 | 5.2688E−04 | 0.0000E+00 | 0.0000E+00 | 0.0000E+00 | 0.0000E+00 |
| S13 | 6.2339E−05 | −5.3837E−06 | 1.9834E−07 | 0.0000E+00 | 0.0000E+00 | 0.0000E+00 | 0.0000E+00 |
| S14 | −6.2890E−03 | 1.5099E−03 | −2.5709E−04 | 3.0295E−05 | −2.3474E−06 | 1.0750E−07 | −2.2029E−09 |

FIG. 12A illustrates a longitudinal aberration curve of the optical imaging lens assembly in Embodiment 6, which represents that a convergence focus of light rays of different wavelengths is deviated after the light rays pass through the lens. FIG. 12B illustrates a lateral color curve of the optical imaging lens assembly in Embodiment 6, which represents a deviation of different image heights of the light rays on the imaging surface after the light rays pass through the lens. FIG. 12C illustrates an astigmatism curve of the optical imaging lens assembly of Embodiment 6, which represents a curvature of tangential image surface and a curvature of sagittal image surface. FIG. 12D illustrates a distortion curve of the optical imaging lens assembly of Embodiment 6, which represents distortion magnitude values corresponding to different fields of view. FIGS. 12A-12D illustrate that the optical imaging lens assembly given in Embodiment 6 is capable of achieving good imaging quality.

To summarize, Embodiments 1-6 separately satisfy relationships shown in Table 13.

TABLE 13

| | embodiment | | | | | |
|---|---|---|---|---|---|---|
| Conditional expression | 1 | 2 | 3 | 4 | 5 | 6 |
| TTL/f | 0.96 | 0.97 | 0.97 | 0.97 | 0.98 | 0.97 |
| ImgH/tan(Semi-FOV) (mm) | 8.56 | 8.44 | 8.39 | 8.39 | 8.40 | 8.39 |
| TTL/f/tan(Semi-FOV) | 2.73 | 2.73 | 2.73 | 2.73 | 2.73 | 2.73 |
| tan(Semi-FOV)* Fno | 0.70 | 0.71 | 0.72 | 0.71 | 0.71 | 0.72 |
| EPD/ImgH | 1.36 | 1.34 | 1.33 | 1.33 | 1.33 | 1.33 |
| (f1 + f2 + f3)/f123 | 0.81 | 0.84 | 0.70 | 0.46 | 0.44 | 0.83 |
| f123/f | 0.45 | 0.46 | 0.43 | 0.45 | 0.44 | 0.47 |
| (f4 + f5)/f | −1.86 | −1.80 | −1.51 | −1.64 | −1.66 | −1.81 |
| TD/(CT7 + T67) | 2.69 | 2.65 | 2.98 | 2.78 | 2.76 | 2.83 |
| (T12 + T23 + T34)/T45 | 0.59 | 0.66 | 0.70 | 0.57 | 0.57 | 0.69 |
| T67/(T45 + T56) | 1.76 | 1.90 | 1.14 | 1.15 | 1.13 | 1.39 |
| V5/V6 | 2.16 | 2.16 | 2.16 | 2.16 | 2.16 | 2.16 |
| f4/R7 | 1.88 | 1.74 | 1.58 | 1.43 | 1.41 | 1.29 |
| f/R10 − f/R9 | 2.44 | 2.58 | 2.64 | 2.49 | 2.40 | 2.10 |

The disclosure further provides an imaging device, and an electronic photosensitive element thereof may be a charge coupled device (CCD) or a complementary metal-oxide-semiconductor (CMOS) element. The imaging device may be a standalone imaging device, for example, a digital camera, or may be an imaging module integrated on a mobile electronic apparatus, for example, a cell phone. The imaging device is equipped with the optical imaging lens assembly described above.

The above description is merely illustrative of preferred examples of the disclosure and of principles of the technology employed. It should be understood by those skilled in the art that the scope of the protection referred to in the disclosure is not limited to the technical solutions in which the above-described technical features are specifically combined, but also encompasses other technical solutions in which the above-described technical features or equivalent features thereof are arbitrarily combined without departing from the disclosure concept. for example, technical solutions formed by interchanging the features described above with (but not limited to) technical features disclosed in this application that have similar functions.

What is claimed is:

1. An optical imaging lens assembly, sequentially comprising from an object side to an image side along an optical axis:
a first lens having a refractive power;
a second lens having a negative refractive power;
a third lens having a refractive power;
a fourth lens having a negative refractive power;
a fifth lens having a negative refractive power;
a sixth lens having a refractive power, an object-side surface thereof being a concave surface, and an image-side surface thereof being a convex surface; and
a seventh lens having a refractive power; wherein
TTL, a distance from an object-side surface of the first lens to an imaging surface of the optical imaging lens assembly along the optical axis and f, a total effective focal length of the optical imaging lens assembly satisfy TTL/f<1, and
ImgH, a half of a diagonal length of an effective pixel region on the imaging surface and Semi-FOV, a half of a maximum field of view of the optical imaging lens assembly satisfy 8 mm<ImgH/tan (Semi-FOV).

2. The optical imaging lens assembly according to claim 1, wherein 8 mm<ImgH/tan(Semi-FOV)<10 mm, and 0<TTL/f<1.

3. The optical imaging lens assembly according to claim 1, wherein TTL, the distance from the object-side surface of the first lens to the imaging surface along the optical axis, f, the total effective focal length of the optical imaging lens assembly, and Semi-FOV, the half of the maximum field of view of the optical imaging lens assembly satisfy:
2.5<TTL/f/tan(Semi-FOV).

4. The optical imaging lens assembly according to claim 1, wherein Semi-FOV, a half of the maximum field of view of the optical imaging lens assembly and Fno, an f number of the optical imaging lens assembly satisfy:
0.5<tan(Semi-FOV)*Fno<1.

5. The optical imaging lens assembly according to claim 1, wherein EPD, an entrance pupil diameter of the optical imaging lens assembly and ImgH, a half of the diagonal length of the effective pixel region on the imaging surface satisfy:
1<EPD/ImgH<1.5.

6. The optical imaging lens assembly according to claim 1, wherein f1, an effective focal length of the first lens, f2, an effective focal length of the second lens, f3, an effective focal length of the third lens, and f123, a combined focal length of the first lens, the second lens, and the third lens satisfy:
(f1+f2+f3)/f123<1.

7. The optical imaging lens assembly according to claim 1, wherein f123, a combined focal length of the first lens, the second lens and the third lens and f, the total effective focal length of the optical imaging lens assembly satisfy:
f123/f<0.5.

8. The optical imaging lens assembly according to claim 1, wherein f4, an effective focal length of the fourth lens and f5, an effective focal length of the fifth lens satisfy:
2<(f4+f5)/f<0.

9. The optical imaging lens assembly according to claim 1, wherein TD, a distance from an object-side surface of the first lens to an image-side surface of the seventh lens along the optical axis, CT7, a center thickness of the seventh lens, and T67, a spacing distance between the sixth lens and the seventh lens along the optical axis satisfy:
2.5<TD/(CT7+T67)<3.

10. The optical imaging lens assembly according to claim 1, wherein T12, a spacing distance between the first lens and the second lens along the optical axis, T23, a spacing distance between the second lens and the third lens along the optical axis, T34, a spacing distance between the third lens and the fourth lens along the optical axis and T45, a spacing distance between the fourth lens and the fifth lens along the optical axis satisfy:
(T12+T23+T34)/T45<1.

11. The optical imaging lens assembly according to claim 1, wherein T45, a spacing distance between the fourth lens and the fifth lens along the optical axis, T56, a spacing distance between the fifth lens and the sixth lens along the optical axis, and T67, a spacing distance between the sixth lens and the seventh lens along the optical axis satisfy:
1<T67/(T45+T56)<2.

12. The optical imaging lens assembly according to claim 1, wherein Nmin, a minimum value of refractive indexes of the first lens to the seventh lens satisfy:
1.5<N min.

13. The optical imaging lens assembly according to claim 1, wherein V5, an Abbe number of the fifth lens and V6, an Abbe number of the sixth lens satisfy:
2<V5/V6<3.

14. The optical imaging lens assembly according to claim 1, wherein f4, an effective focal length of the fourth lens and R7, a curvature radius of an object-side surface of the fourth lens satisfy:
1<f4/R7<2.

15. The optical imaging lens assembly according to claim 1, wherein f, a total effective focal length of the optical imaging lens assembly, R9, a curvature radius of an object-side surface of the fifth lens, and R10, a curvature radius of an image-side surface of the fifth lens satisfy:
2<f/R10−f/R9<3.

16. An optical imaging lens assembly, sequentially comprising from an object side to an image side along an optical axis:
a first lens having a refractive power;
a second lens having a negative refractive power;
a third lens having a refractive power;
a fourth lens having a negative refractive power;
a fifth lens having a negative refractive power;
a sixth lens having a refractive power, an object-side surface thereof being a concave surface, and an image-side surface thereof being a convex surface; and a seventh lens having a refractive power; wherein
TTL/f<1, and
2.5<TTL/f/tan(Semi-FOV),
TTL being a distance from an object-side surface of the first lens to an imaging surface along the optical axis, f being a total effective focal length of the optical imaging lens assembly, and Semi-FOV being half of a maximum field of view of the optical imaging lens assembly.
